(19) United States
(12) Patent Application Publication
(10) Pub. No.: US 2008/0069473 A1
(43) Pub. Date: Mar. 20, 2008

(54) IMAGE MANAGEMENT METHOD AND IMAGE PROCESSING APPARATUS

(76) Inventor: Yoshiharu TOJO, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/857,180

(22) Filed: Sep. 18, 2007

(30) Foreign Application Priority Data
Sep. 19, 2006 (JP) 2006-253508
Sep. 7, 2007 (JP) 2007-233053

(51) Int. Cl. G06K 9/36

(52) U.S. Cl. 382/276

(57) ABSTRACT

In an image management method for managing images, a scan part generates a supplementary original image by scanning a supplementary original; and a portion image management part manages a plurality of portion images corresponding to a plurality of supplementary portions extracted by using the supplementary original image.

### BACKGROUND OF THE INVENTION

1. Field of the Invention

The present invention generally relates to an image management method and image processing apparatus, which manage portion images showing supplementary portions added to an original.

2. Description of the Related Art

Japanese Laid-open Patent Application No. 2005-234790 discloses a handwritten slip processing system for acquiring information from a handwritten slip for processing the handwritten slip. The handwritten slip processing system recognizes a handwritten portion on a paper slip, and acquires information selected on the paper slip and handwritten information.

However, in a conventional handwritten slip system, since it is assumed to use a predetermined slip in which a handwritten area is formatted, it is difficult to manage an arbitrary handwritten memo.

Since there are no means for managing handwritten memos formed on a paper document on which a designated area is not formed, it cannot be realized to promptly extract the handwritten memo and a location where the handwritten memo is added on the paper document.

Moreover, in a case in which copies of a paper document are distributed to a plurality of persons and comments with respect to the paper document are gathered from each of the persons, it is required to separately gather a document in which the comments are described from each of the persons. Alternatively, the persons are required to return the distributed copies on which memos are handwritten to a distributor, and the distributor is also required to read a general comment from the memos handwritten on the copies of the paper document by the plurality of persons.

### SUMMARY OF THE INVENTION

The present invention solves or reduces one or more of the above problems.

According to one aspect of the present invention, there is provided an image management method for managing images, wherein a scan part generates a supplementary original image by scanning a supplementary original; and a portion image management part manages a plurality of portion images corresponding to a plurality of supplementary portions extracted by using the supplementary original image.

In the image management method, the portion image management part may manage subject items indicating subjects to which the plurality of portion images are related by corresponding to the plurality of portion images, and the image composition part selectively may compose the plurality of portion images and an original image based on the subject items.

The above-described image management method may be implemented in an image processing apparatus.

Therefore, it is possible to manage the portion images showing the supplementary portions which are added to an original by associating with the original. Moreover, since the portion images showing the supplementary portions which are added to the original are managed by corresponding to the subject items, it is possible to display and print out the portion images corresponding to each of the subject items by composing with the original image.

### BRIEF DESCRIPTION OF THE DRAWINGS

In the following, embodiments of the present invention will be described with reference to the accompanying drawings.

FIG. 1 is a diagram showing a first system configuration according to the embodiment of the present invention;

FIG. 2 is a diagram showing a second system configuration according to the embodiment of the present invention;

FIG. 3 is a diagram showing a third system configuration according to the embodiment of the present invention;

FIG. 4 is a diagram showing a fourth system configuration according to the embodiment of the present invention;

FIG. 5 is a diagram showing a fifth system configuration;

FIG. 6 is a diagram for explaining an image storage method in a difference image process;

FIG. 7 is a diagram for explaining a sequence for extracting difference images in a case in that an image processing apparatus includes a storage area used to store original images;

FIG. 8 is a diagram for explaining a sequence for extracting the difference images in a case in that a server manages the original images;

FIG. 9 is a diagram for explaining a sequence in a case in that a difference image extraction process is conducted by the server;

FIG. 10 is a diagram showing a first data structure of a difference image management table;

FIG. 11 is a diagram showing a second data structure of the difference image management table;

FIG. 12 is a diagram showing a third data structure of the difference image management table;

FIG. 13 is a diagram showing an example of a document list screen;

FIG. 14 is a diagram showing an example of a preview screen;

FIG. 15 is a diagram for explaining the sequence in a case of displaying and printing out all pages including pages composed with the difference images;

FIG. 16 is a diagram for explaining the sequence in the case of browsing and printing out only pages to which the user wrote memos by hand and which are composed with the difference images;

FIG. 17A is a diagram showing a STATE (A) due to the difference image acquisition request in FIG. 15 and FIG. 16, FIG. 17B is a diagram showing a STATE (B) due to the original image acquisition request in FIG. 15 and FIG. 16, and FIG. 17C is a diagram showing a STATE (C) due to the image composition in FIG. 15 and FIG. 16;

FIG. 18 is a diagram for explaining the sequence in a case of composing the difference images of handwritten memos of the user with areas including the difference images in the original image to display and print out;

FIG. 19A is a diagram showing a STATE (A-2) due to the difference image acquisition request in FIG. 18, FIG. 19B is a diagram showing a STATE (B-2) due to the original image acquisition request in FIG. 18, FIG. 19C is a diagram showing a STATE (C-2) due to the image composition in FIG. 18, and FIG. 19D is a diagram showing a STATE (D-2) due to the image layout request in FIG. 18;

FIG. 20 is a diagram for explaining an area including the difference image;

FIG. 21 is a diagram showing an example of a composed layout image;

FIG. 22A and FIG. 22B are diagrams for explaining an operation of the user to change a size of the composed image;

FIG. 23A and FIG. 23B are diagrams for explaining a process for composing handwritten memos of a plurality of users into a single document;

FIG. 24 is a diagram showing an example of the composed layout image in which only handwritten memos made by the plurality users are laid out;

FIG. 25 is a diagram showing an example of a preview screen allowing indication of a range of the composed subject by a difference image creation date;

FIG. 26 is a diagram showing an example of the document list screen for extracting the difference images 32 regarding an indicated business;

FIG. 27 is a diagram for explaining a sequence for relating the difference images 32 extracted by scanning the supplementary original to the business;

FIG. 28 is a diagram showing an example of the preview screen allowing indication of a range or the composition subject by the business;

FIG. 29 is a diagram for explaining a sequence in a case of displaying and printing out pages at which the difference images corresponding to the business are composed;

FIG. 30 is a diagram showing an example of a document list screen for extracting the difference images by indicating the business, according to the present invention;

FIG. 31 is a diagram for explaining a sequence for storing the difference images extracted by scanning the supplementary original;

FIG. 32 is a diagram showing an example of the preview screen allowing indication of a range of the composition subject by a storage folder; and

FIG. 33 is a diagram for explaining a sequence in a case of displaying and printing out pages at which the difference images stored in the storage folder are composed.

### DESCRIPTION OF THE PREFERRED EMBODIMENT

In the following, an embodiment of the present invention will be described with reference to the accompanying drawings. In the embodiment, a supplemental portion is defined as any one of portions which are not originally printed as an original document, such as a handwritten portion added by a user, a stamp portion applied by the user, a sticker portion attached by the user, a barcode portion applied by the user, or a like. A difference image is defined as an image showing the supplemental portion.

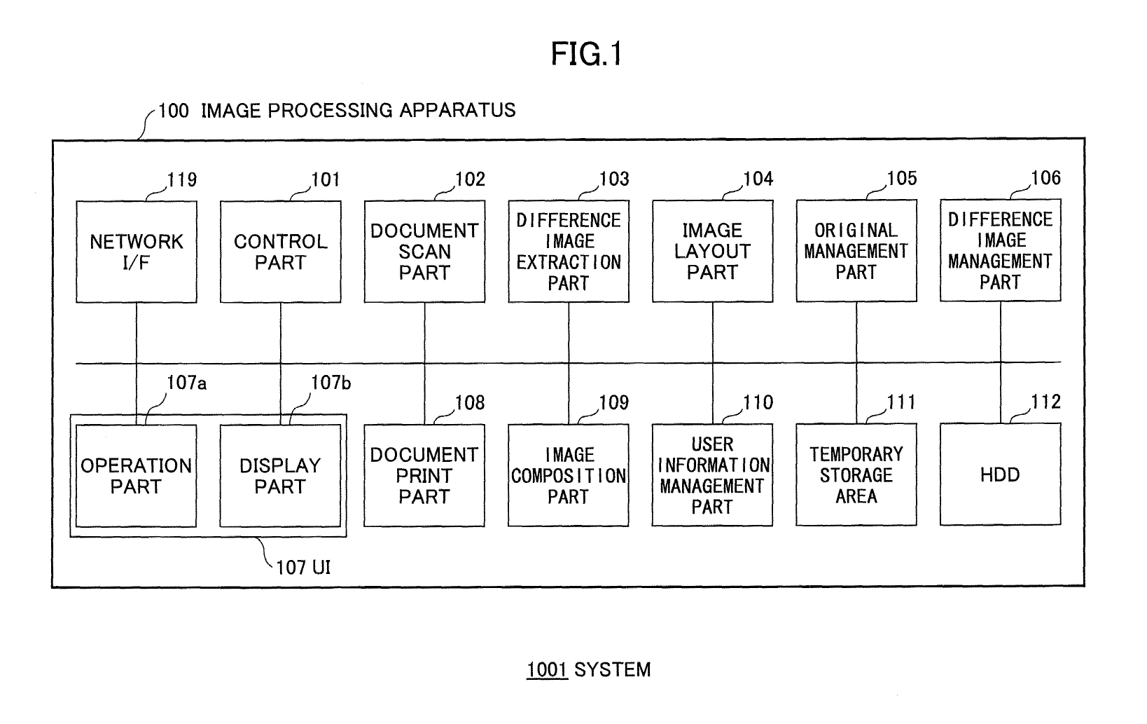

FIG. 1 is a diagram showing a first system configuration according to the embodiment of the present invention. In a system 1001 shown in FIG. 1, an image processing apparatus 100 is an apparatus including functions for conducting various image formations such as a printer, a copier, a facsimile, a scanner, and a like. The image processing apparatus 100 includes a control part 101, a document scan part 102, a difference image extraction part 103, an image layout part 104, an original management part 105, a difference image management part 106, a UI (User Interface) 107, a document print part 108, an image composition part 109, a user information management part 110, a temporary storage area 111, an HDD (Hard Disk Device) 112, and a network I/F (InterFace) 119.

The control part 101 includes a CPU (Central Processing Unit) and a memory, and controls the entire image processing apparatus. The document scan part 102 includes a scanner and is a processing part that creates an electronic image (hereinafter, simply called an image) by scanning an original document of a paper sheet. The difference image extraction part 103 is a processing part that extracts a difference between an original image of the original which is not supplemented and a supplementary original image including at least one supplemental portion which is added to the original, as a difference image.

The image layout part 104 is a processing part that automatically layouts a plurality of images onto an image of one page. The original management part 105 is a processing part that manages the original image created and stored in the HDD 112 by scanning the original which no supplemental portion is added onto and which copies are distributed. The difference image management part 106 is a processing part that manages difference images stored in the HDD 112 or the like.

The UI part 107 interfaces between the user and the image processing apparatus 100, and includes an operation part 107a and a display part 107b. The operation part 107a enables the user to operate the image processing apparatus 100. The display part 104b displays information concerning various image processes to the user.

The document print part 108 is a processing part that prints an image on a paper sheet. The image composition part 109 is a processing part that composes the difference image and the original image. The user information management part 110 is a processing part that manages information of users who use the image processing apparatus 100 and conducts a user authentication. The temporary storage area 111 is a storage area temporarily used for an image composition.

The HDD 112 stores various data being managed, in addition to original images, difference images showing the supplemental portions, and a like. The network I/F 119 is an interface for the image process apparatus 100 to communicate other devices through a LAN (Local Area Network), an Internet, and a like.

Alternatively, a network configuration can be considered in that a server includes the difference image extraction part 103, the image layout part 104, the original management part 105, the difference image management part 106, the image composition part 109, the user information management part 110, and the temporary storage area 111.

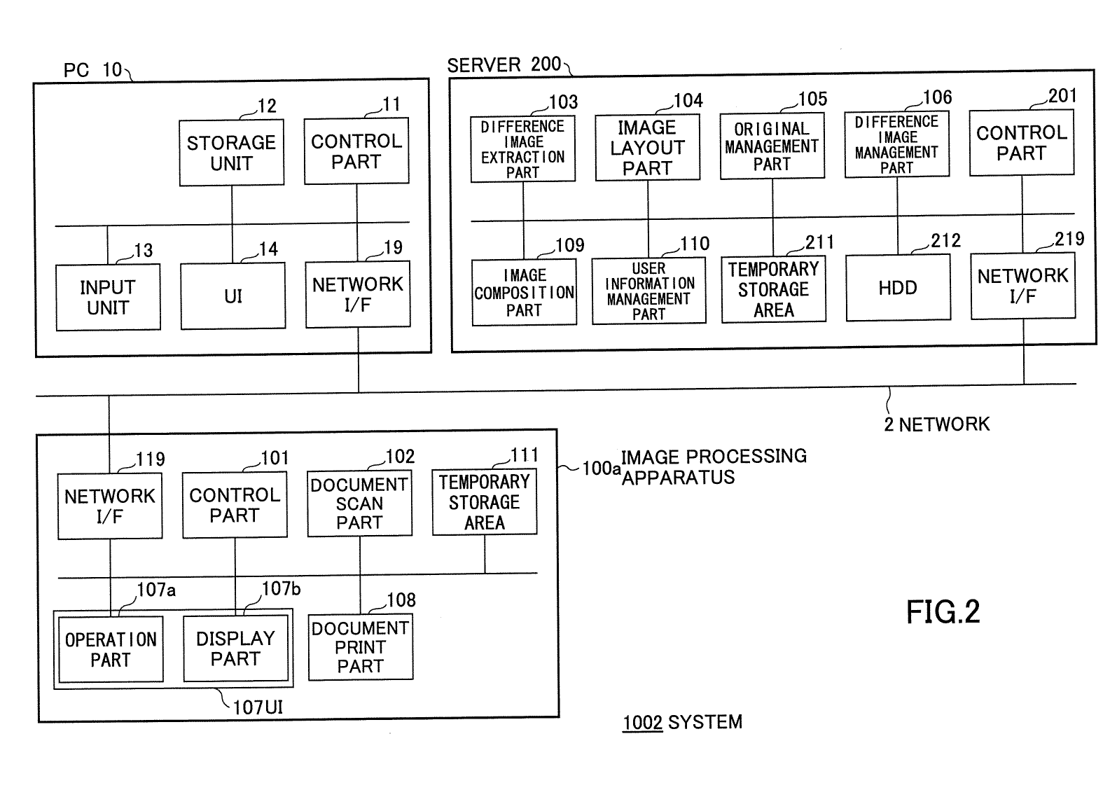

FIG. 2 is a diagram showing a second system configuration according to the embodiment of the present invention. In a system 1002 shown in FIG. 2, an image processing apparatus 100a, a PC 10, and a server 200 are connected through a network 2. In FIG. 2, parts that are the same as the ones in FIG. 1 are indicated by the same reference numerals and the explanation thereof will be omitted.

The image processing apparatus 10a includes a control part 101 that controls the entire image processing apparatus 100a, a document scan part 102, a UI 107, a document print part 108, a temporary storage area 111, and a network I/F 119 that communicates through the network 2.

The server 200 includes a control part 201 that includes a CPU and a memory and controls the entire server 200, an difference image extraction part 103, an image layout part 104, an original management part 105, an difference image management part 106, an image composition part 109, a user information management part 110, a temporary storage area 211, an HDD 212, and a network I/F 219 that communicates through the network 2. The HDD 212 stores original images, difference images, user information, and a like.

The PC 10 includes a control part 11 that includes a CPU and a memory and controls the entire PC 10, a storage unit 12 that stores data necessary for processes of the PC 10, an input unit 13 that controls data inputs, a UI 14 that controls a user interface, and a network I/F 19 that communicates through the network 2.

As described above, the server 200 may include the difference image extraction part 103, the image layout part 104, the original management part 105, the difference image management part 106, the image composition part 109, and the user information management part 110. By this configuration, in a case that a plurality of the image processing apparatuses 10a are connected to the network 2, it is possible to centralize processes for extracting, composing, and laying out images and a process for managing information, to the server 200. Therefore, it is possible to improve reliability in handling various data and processes.

The PC 10 may send a request concerning an difference image process to the image processing apparatus 100a, and may receive a result notice of the difference image process conducted by the server 200 through the image processing apparatus 10a. Alternatively, the PC 10 may browse the original image and the difference image directly from the server 200. The PC 10 may browse the original image and the difference image being stored in the server 200, through the image processing apparatus 100a.

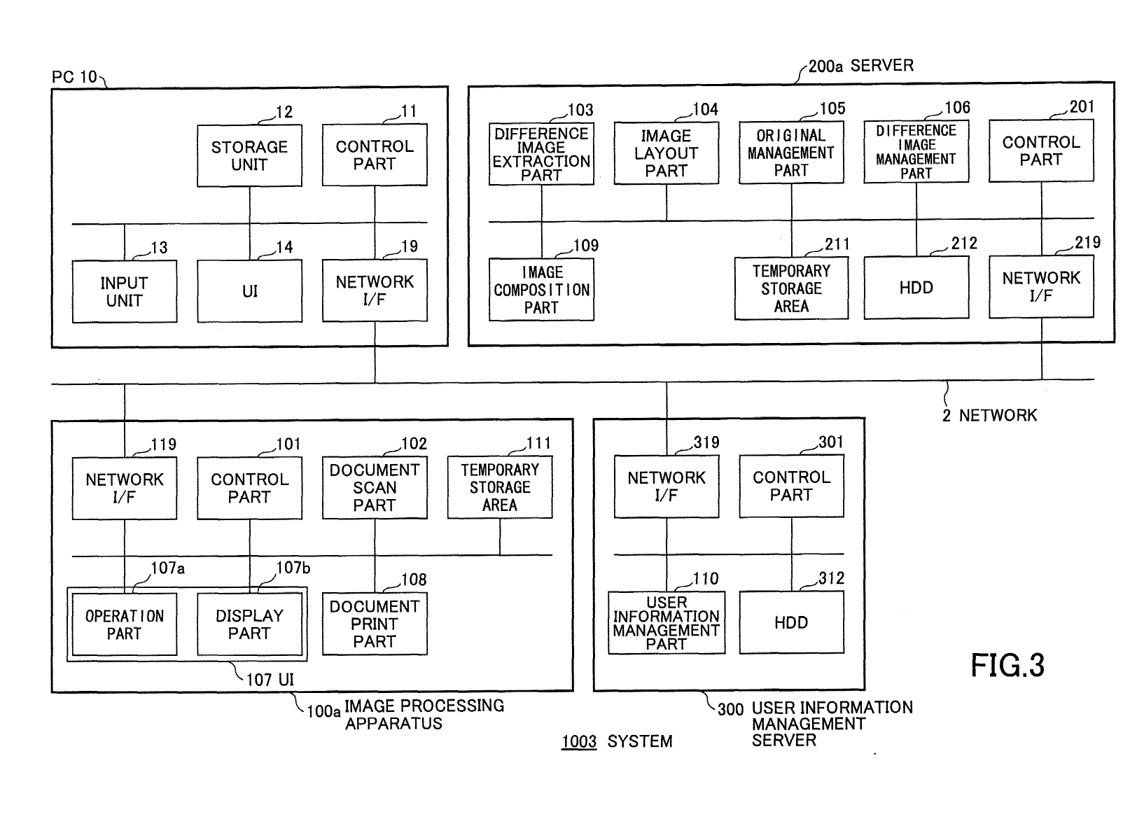

FIG. 3 is a diagram showing a third system configuration according to the embodiment of the present invention. In a system 1003 shown in FIG. 3, an image processing apparatus 100a, a PC 10, a server 200a, and a user information management server 300 are connected through a network 2. In FIG. 3, parts that are the same as the ones in FIG. 1 and FIG. 2 are indicated by the same reference numerals and the explanation thereof will be omitted.

A configuration of the server 200a is the same as that of the server 200 shown in FIG. 2 excluding the user information management part 110. Accordingly, the HDD 212 stores the original images, the difference images, and the like.

The user information management server 300 includes a control part 301 that includes a CPU and a memory and controls the entire user information management server 300, a user information management part 110, an HDD 312, and a network I/F 319 that communicates through the network 2. The HDD 312 stores the user information and the like.

When the PC 10 accesses the image processing apparatus 100a, the image processing apparatus 10a requests a user authentication of the user information management server 300 and controls an access based on a result of the user authentication. Alternatively, when the PC 10 accesses the server 200a, the server 200a may request the user authentication of the user information management server 300 and controls the access based on the result of the user authentication.

The system 1003 is functionally configured to conduct the user authentication other than an access concerning an image process.

In the system 1003, similar to the system 1001 shown in FIG. 2, the PC 10 may send a request concerning an difference image process to the image processing apparatus 10a, and may receive a result of the difference image process conducted by the server 200a through the image processing apparatus 100a. Alternatively, the PC 10 may browse the original image, the difference image, and the like directly from the server 200a. The PC 10 may browse the original image, the difference image, and the like being stored in the server 200a through the image processing apparatus 100a.

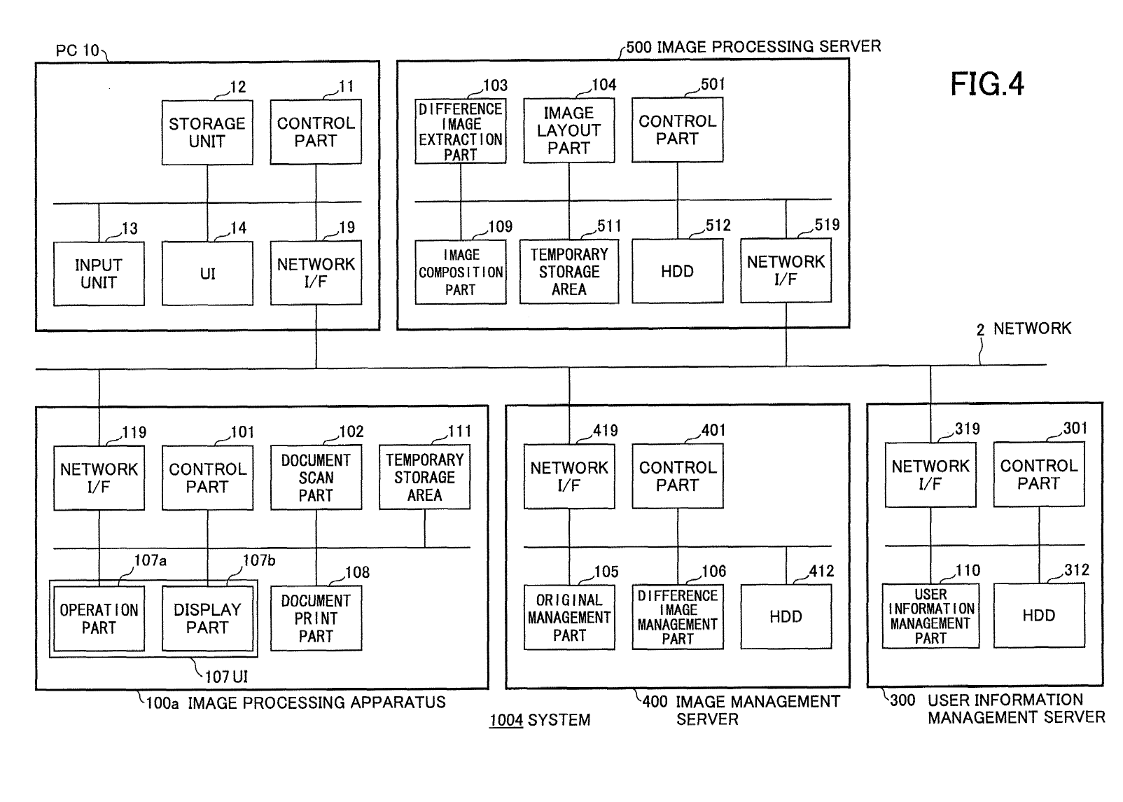

FIG. 4 is a diagram showing a fourth system configuration according to the embodiment of the present invention. In a system 1004 shown in FIG. 4, an image processing apparatus 100a, a PC 10, a user information management server 300, an image management server 400, and an image processing server 500 are connected through a network 2. In FIG. 4, parts that are the same as the ones in FIG. 1 through FIG. 3 are indicated by the same reference numerals and the explanation thereof will be omitted. Also, configurations of the image processing apparatus 100a, the PC 10, and the user information management server 300 are the same as the ones shown in FIG. 3, and the explanation thereof will be omitted.

In the system 1004, the image management server 400 is provided with the original management part 105 and the difference image management part 106 of the server 200 shown in FIG. 2, the image processing server 500 is provided with the difference image extraction part 104, an image layout part 104, and the image composition part 109 of the server 200 shown in FIG. 2, and the user information management server 300 is provided with the user information management part 110 of the server 200 shown in FIG. 2.

The image management server 400 includes a control part 401 that includes a CPU and a memory and controls the entire image management server 400, the original management part 105, the difference image part 106, an HDD 412, and a network I/F 419 that communicates through the network 2. The HDD 412 stores original images, difference images, and a like.

The image processing server 500 includes a control part 501 that includes a CPU and a memory and controls the entire image processing server 500, the difference image extraction part 103, the image layout part 104, the image composition part 109, a temporary storage area 511, and a network I/F 519 that communicates through the network 2. A configuration of the image processing server 500 is the same as the one of the server 200 shown in FIG. 2 excluding the original management part 105, the difference image management part 106, the user information management part 110.

In the system 1004, the user information management server 300 and the image management server 400 are configured to reduce a possibility of data loss, and the image processing server 500 is configured to realize a higher process speed. Accordingly, the system 1004 is configured by apparatuses having a performance corresponding to a requirement.

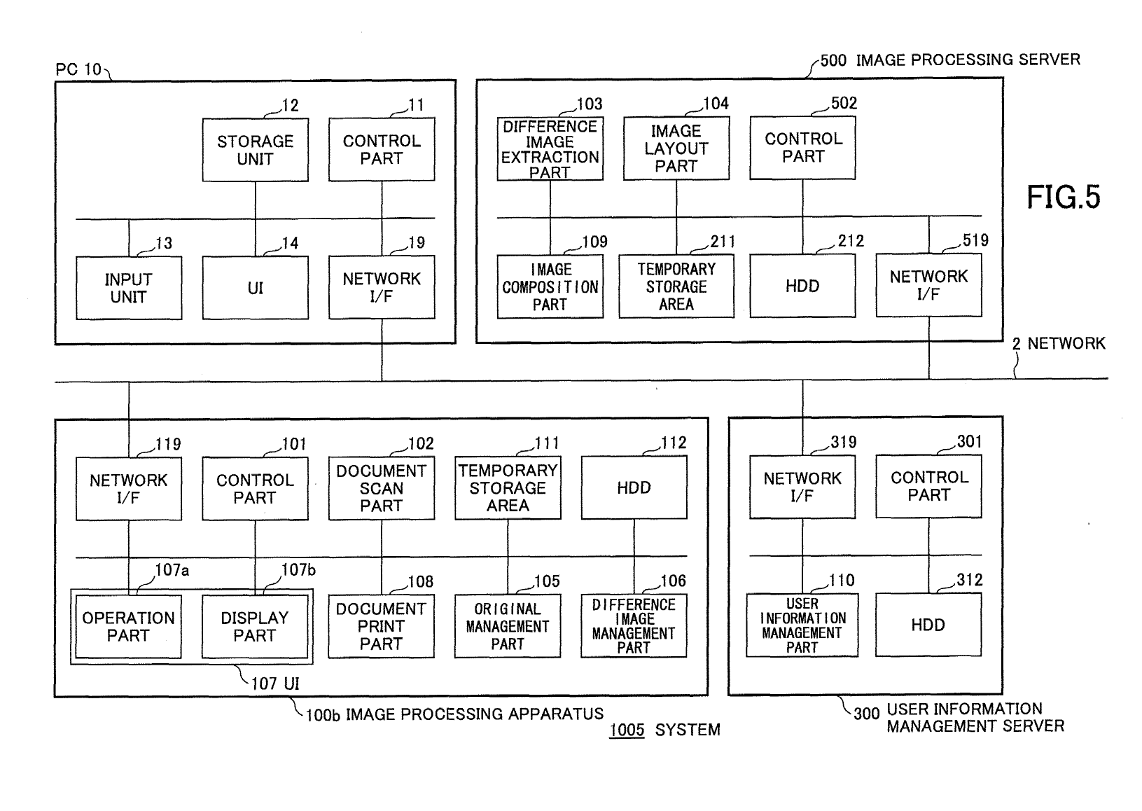

FIG. 5 is a diagram showing a fifth system configuration according to the embodiment of the present invention. In a system 1005 showing in FIG. 5, an image processing apparatus 100b, a PC 10, the user information management server 300, and an image processing server 500 are connected through the network 2. In FIG. 5, parts that are the same as the ones in FIG. 4 are indicated by the same reference numerals and the explanation thereof will be omitted. Configurations of the PC 10, the user information management server 300, and the image processing server 500 are the same as the ones shown in FIG. 3 and the explanation thereof will be omitted.

In the system 1005, the image processing apparatus 100b is provided with the control part 101, the document scan part 102, the original management part 105, the difference image management part 106, the UI 107, the document print part 108, the temporary storage area 111, the HDD 112, and the network I/F 119 of the image processing apparatus 100 shown in FIG. 1. Accordingly, in the system 1005, the image management server 400 of the system 1004 shown in FIG. 4 is not required.

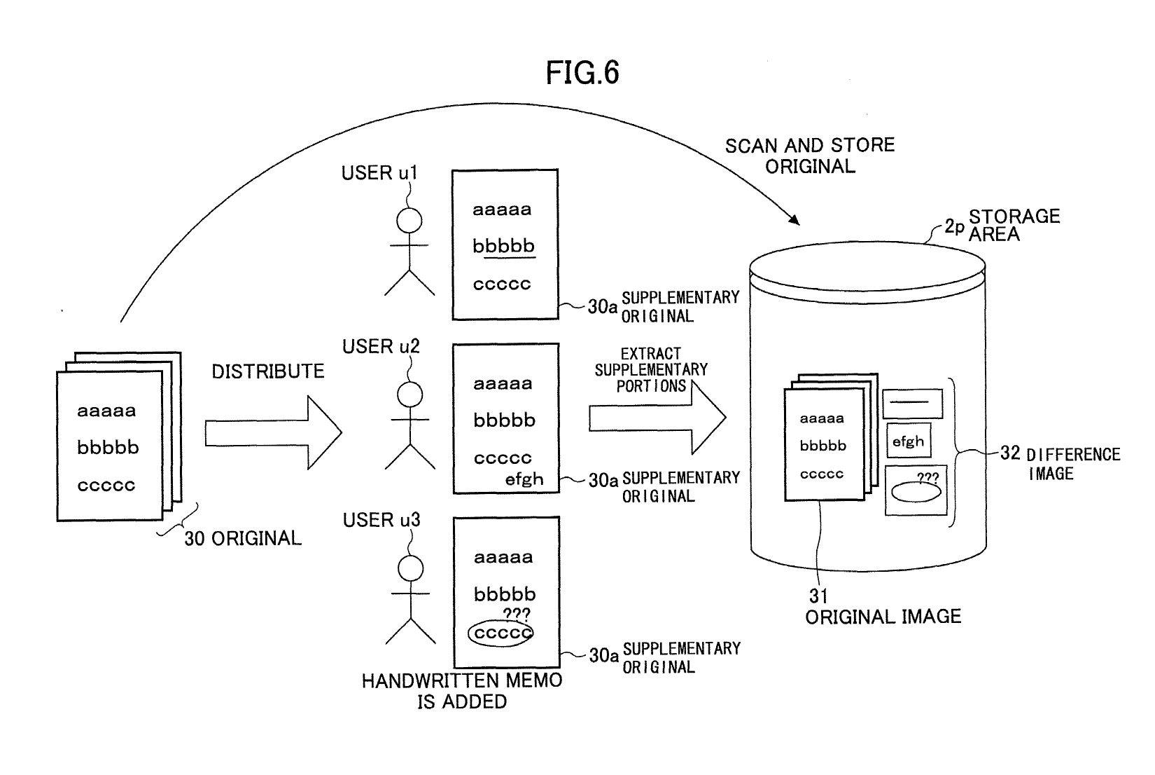

Next, a storage method of the original images and the difference images including supplemental portions will be briefly described with reference to FIG. 6. In FIG. 6, an original image 31 created by scanning an original 30 is first stored in a storage area 2p, copies of the original 30 are distributed to a plurality of users u1, u2, and u3. The copies of the original 30 are the same as the original 30 and generically called original 30.

The storage area 2p stores the original image 31 by the original management part 105. The storage area 2p is collectively shown as a storage area for storing the difference images 32 by the difference image management part 106. It should be noted that it is not defined by the storage area 2p to store the original image 31 and the difference image 32 in a single hard disk or to store the original image 31 and the difference image 32 in physically separated hard disks.

After the originals 30 are distributed and individually supplemented by handwriting or a predetermined process of the users u1, u2, and u3, based on difference information between an image scanned from each of the supplementary originals 30a including supplemented portions and the original image 31 being stored in the storage area 2p, the difference image 32 including each of the supplementary portions is extracted and stored in the storage area 2p.

The storage area 2p stores the original image 31 and the difference images 32 which are extracted. Each of the image difference 32 is related to information concerning the original image 31.

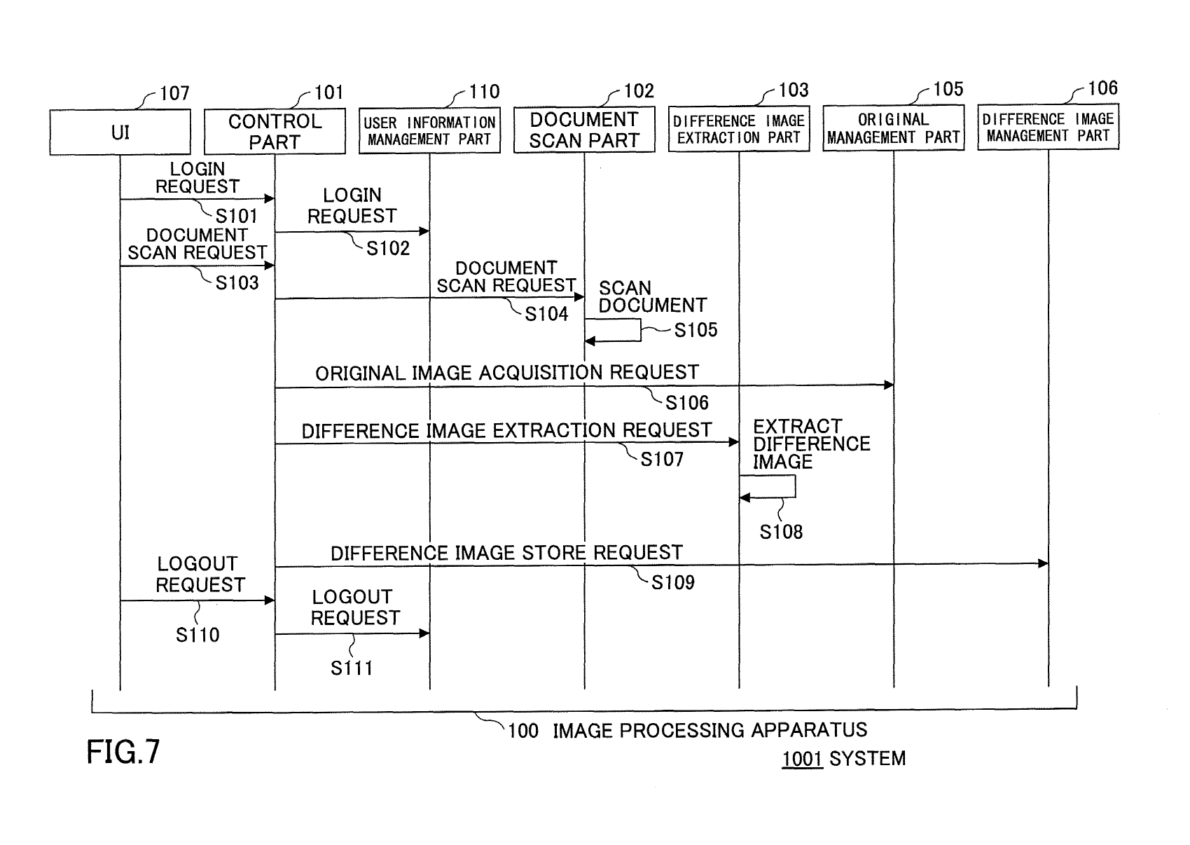

Sequences for storing the difference image 32 in the storage area 2p will be described. First, a case in that the image processing apparatus 100 includes the storage area 2p to store the original image 31 will be described with reference to FIG. 7. FIG. 7 is a diagram for explaining a sequence for extracting the difference images 32 in the case in that the image processing apparatus 100 includes the storage area 2p to store the original image 31.

In FIG. 7, when a user logs in at the UI 107 of the image processing apparatus 100, the UI 107 sends a login request to the control part 101 (step S101), the control part 101 sends the login request to the user information management part 110 (step S102). In order to log in, the user may input a user ID or uses a card to input the user ID by a card reader at the UI 107.

After login, when the user operates to scan the supplementary original 30a, the UI 107 sends a document scan request to the control part 101 (step S103). The control part 101 sends the document scan request to the document scan part 102 (step S104).

When the document scan part 102 reads the document scan request from the control part 101, the document scan part 102 controls the scanner to read the supplementary original 30a set by the user and creates a supplementary original image (step S105). For example, the document scan part 102 indicates the supplementary original image to the control part 101 by sending information indicating storage location information of the temporary storage area 111.

The control part 101 sends the original management part 105 an original image acquisition request for acquiring the original image 31 (step S106). For example, the original management part 105 indicates the original image 31 to the control part 101 by sending information indicating storage location information in the storage area 2p in which the original image 31 is stored.

When the control part 101 acquires the supplementary original image and the original image 31, the control part 101 sends the difference image extraction part 103 an difference image request indicating the original image 31 and the supplementary original image in order to extract the supplementary portions (step S107).

The difference image extraction part 103 acquires the original image 31 and the supplementary original image indicated in the image extraction request from the storage area 2p, acquires differences by conducting an image comparison, and extracts the difference images 32 by a predetermined method so as to include areas of the supplementary portions (step S108). The difference image extraction part 103 informs an extraction result indicating the difference images 32 to the control part 101.

The control part 101 sends an difference image storage request including the extraction result to the difference image storage part 106 in order to store the difference images 32 extracted by the difference image extraction part 103 (step S109). The difference image management part 106 additionally provides an difference image ID to each of the difference images 32 being stored in the temporary storage area 111 based on the extraction result and stores the difference images 32 to the storage area 2p. In this case, the control part 101 may inform the user ID by using the difference image storage request to the difference image management part 106, and the difference image management part 106 may store the user ID informed from the control part 101 in the storage area 2p by corresponding to the difference image ID.

When the difference images are extracted and stored, the user logs out at the UI 107. The UI 107 sends a logout request to the control part 101 (step S110), and the control part 101 sends the logout request to the user information management part 110 (step S111).

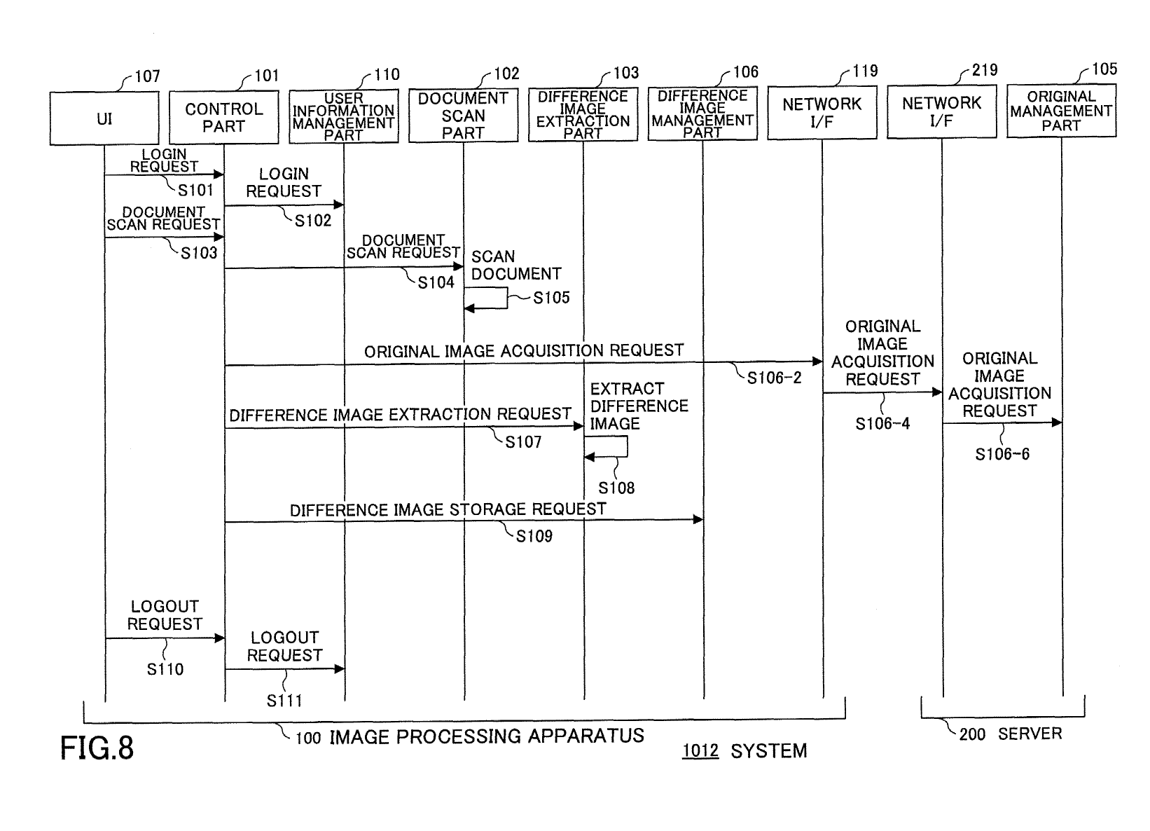

In a case in which the server 200 stores and manages the original images 31 which are not subject to print out or send out, it is possible to centralize the management of the original image 31 at the server 200. It is not required for each image processing apparatus 100 to implement a document management function. The case of managing the original images 31 at the server 200 will be described with reference to FIG. 8.

FIG. 8 is a diagram for explaining a sequence for extracting the difference images 32 in a case in that the server 200 manages the original images 31. In FIG. 8, steps that are the same as the ones in FIG. 7 are indicated by the same reference numerals and the explanation thereof will be omitted. In FIG. 8, in a system 1012 as a variation of the system 1002 shown in FIG. 2, the server 200 is configured to centralize a management of the original images 31, and the image processing apparatus 100a is provided with the difference image extraction part 103, the image layout part 104, the image composition part 109, the user information management part 110, and the like.

Referring to FIG. 8, when a user logs in and operates to scan the supplementary original 30a at the image processing apparatus 100a, the supplementary original 30a is scanned and a supplementary original image is created and stored in the temporary storage area 111 (steps S101 through S105).

Then, the control part 101 of the image processing apparatus 100a sends an original image acquisition request indicating a document ID of the original image 31 to the network I/F 119 in order to acquire the original image 31 from the server 200 (step S106-2). The document ID of the original image 31 is obtained from the user. Alternatively, if the document ID can be read out from the original image 31, the document ID can be also read out similarly from the supplementary original image of the supplementary original 30a. Thus, the document ID may be acquired from the supplementary original image being stored in the temporary storage area 111 by a predetermined document ID reading method.

The network I/F 119 of the image processing apparatus 100a sends an original image acquisition request to the server 200 (step S106-4), the network I/F 219 of the server 200 sends the original image acquisition request received from the image processing apparatus 100a to the original management part 105 of the server 200 (step S106-6). The original management part 105 of the server 200 reads out the original image 31 from the storage area 2p by using the document ID indicated in the original image acquisition request, and sends the original image 31 to the image processing apparatus 10a.

In the image processing apparatus 10a, the difference images 32 between the supplementary original image and the original image 31 are extracted, and the difference image storage request indicating the extraction result and the difference image ID is sent from the control part 101 to the difference image management part 106 (steps S107 through S109).

The difference image management part 106 additionally provides the difference image ID to each of the difference images 32 being stored in the temporary storage area 111 based on the extraction result and stores the difference images 32 in the storage area 2p.

When the supplementary original 30a is scanned and stored, the user logs out at the UI 107 (steps S110 and S111).

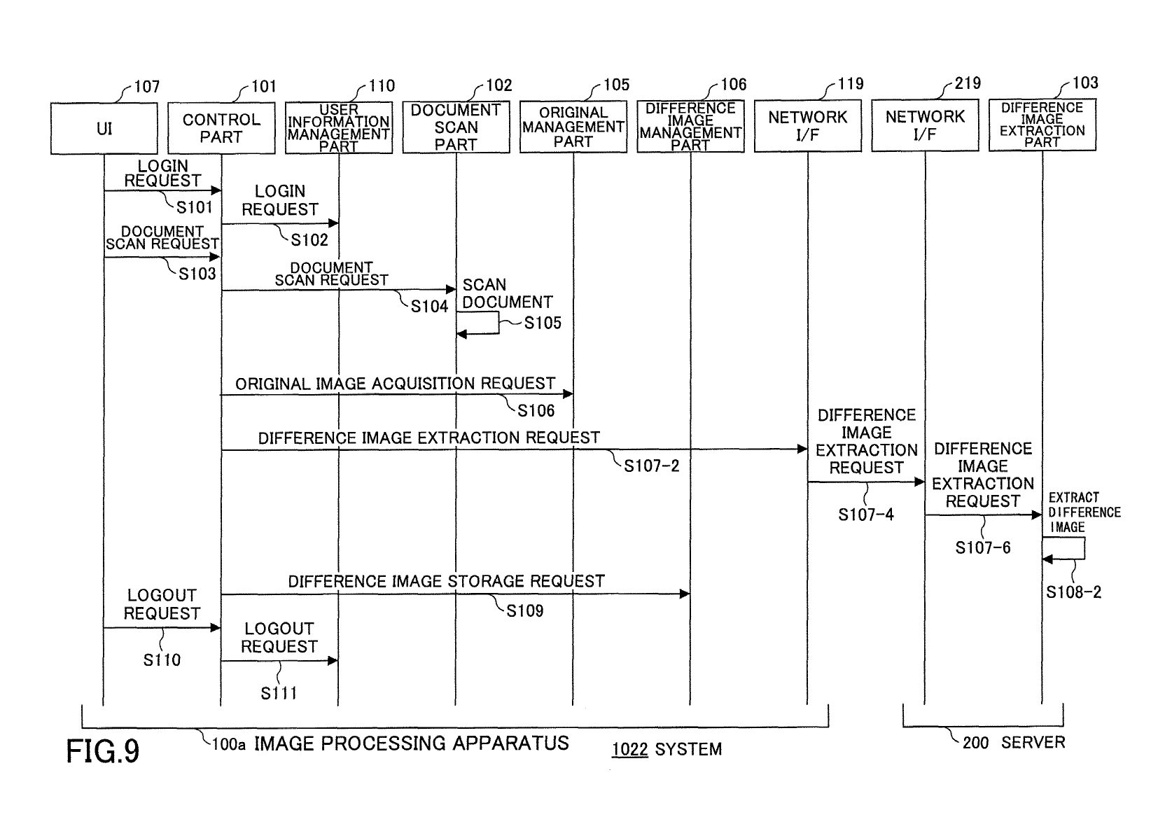

In a case in that an difference image extraction process requires extended processing time in the step S108, a server mounting a CPU of a high speed processor may be configured to execute the difference image extraction process. Without improving a process speed of the image processing apparatus 10a, it is possible to realize the difference image extraction process at higher speed. A case of configuring the server 200 as described above and conducting the difference image extraction process will be described with reference to FIG. 9.

FIG. 9 is a diagram for explaining a sequence in a case in that the difference image extraction process is conducted by the server 200. In FIG. 9, steps that are the same as the ones in FIG. 7 are indicated by the same reference numerals and the explanation thereof will be omitted. In FIG. 9, in a system 1022 as another variation of the system 1002 shown in FIG. 2, the server 200 is configured to conduct the difference image extraction process, and the image processing apparatus 100a is provided with the image layout part 104, the original management part 105, the image composition part 109, the user information management part 110, and the like.

In FIG. 9, when a user logs in and operates at to scan the supplementary original 30a, the supplementary original 30a is scanned and the difference images 32 are stored in the temporary storage area 111 (steps S101 through S105).

When the control part 101 of the image processing apparatus 10a acquires the original image 31 from the original management part 105 (step S106), the control part 101 sends a difference image extraction request including the original image 31 and the supplementary original image to the network I/F 119 to request the server 200 to extract the difference images 32 (step S107-2).

The network I/F 119 of the image processing apparatus 10a sends the difference image extraction request to the server 200 (step S107-4). The network I/F 219 of the server 200 receives the difference image extraction request from the image processing apparatus 100a and sends the difference image extraction request to the difference image extraction part 103 of the server 200 (step S107-6).

The difference image extraction part 103 of the server 200 acquires differences by conducting the image comparison between the original image 31 and the supplementary original image which are included in the difference image extraction request, and extracts the difference images 32 by a predetermined method so as to include an area of each of supplementary portions (step S108-2). The difference image extraction part 103 of the server 200 informs the extraction result indicating the difference image 32 to the control part 101 of the image processing apparatus 100a.

When the control part 101 of the image processing apparatus 10a controls the difference image management part 106 to store the difference images 32 in the storage area 2p (step S109), the user logs out at the UI 107 (steps S101 and S111).

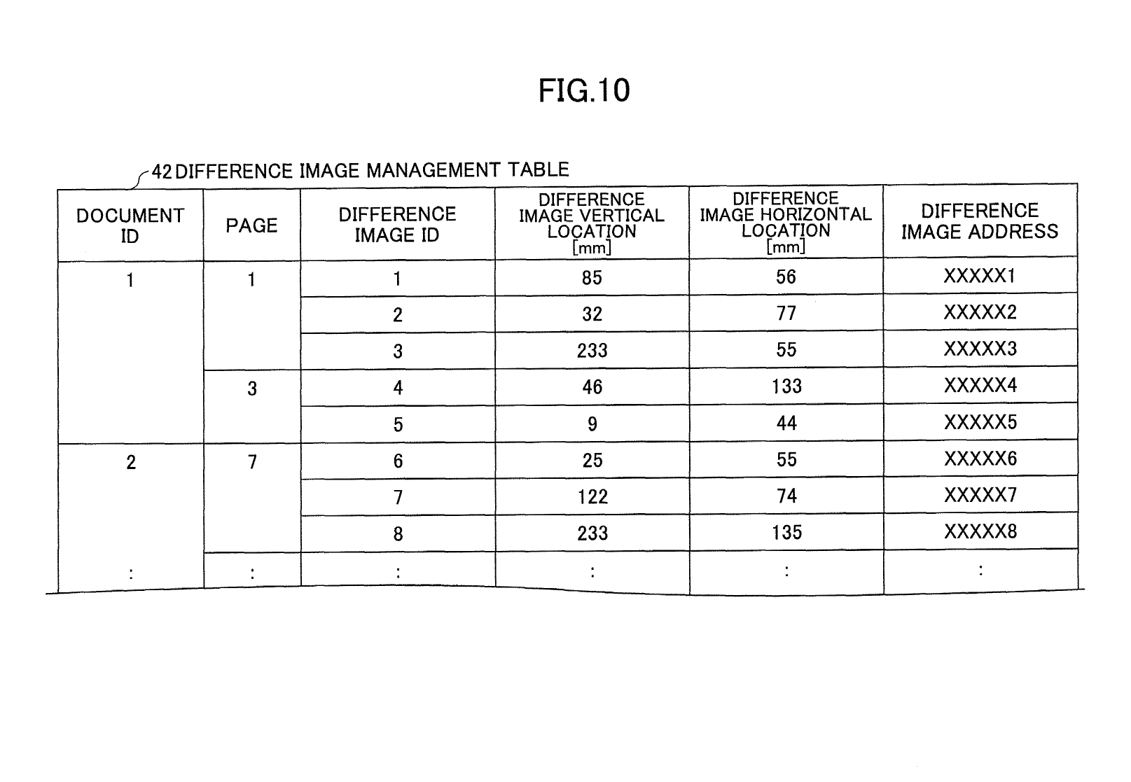

Next, a difference image management table for managing the difference images 32 will be described with reference to FIG. 10. FIG. 10 is a diagram showing a first data structure of the difference image management table. In FIG. 10, the difference image management table 42 includes items of a document ID for specifying the original image 31 of the original 30, a page indicating a page number where a supplementary portion is added in the original 30, a difference image ID for identifying the difference image 32, a difference image vertical location, a difference image horizontal location, a difference image address, and a like. In the difference image management table 42, each of the difference images 32 is associated with the document ID and the page number.

The difference image management table 42 shown in FIG. 10 indicates that the difference images 32 respectively identified by the difference image ID “1”, “2”, and “3” exist at page “1” of the document ID “1”.

The difference image 32 of the difference image ID “1” is placed vertically at “85” mm and horizontally “56” mm from a predetermined location of the page “1”, and its storage location is the difference image address “xxxxx1”. The difference image 32 of the difference image ID “2” is placed vertically at “32” mm and horizontally “77” mm from the predetermined location of the page “1”, and its storage location is the difference image address “xxxxx2”. Also, The difference image 32 of the difference image ID “3” is placed vertically at “233” mm and horizontally “55” mm from the predetermined location of the page “1”, and its storage location is the difference image address “xxxxx3”.

Similarly, with respect to the page “3” of the document ID “1”, the page “7” of the document ID “2”, . . . , the difference images 32 are managed.

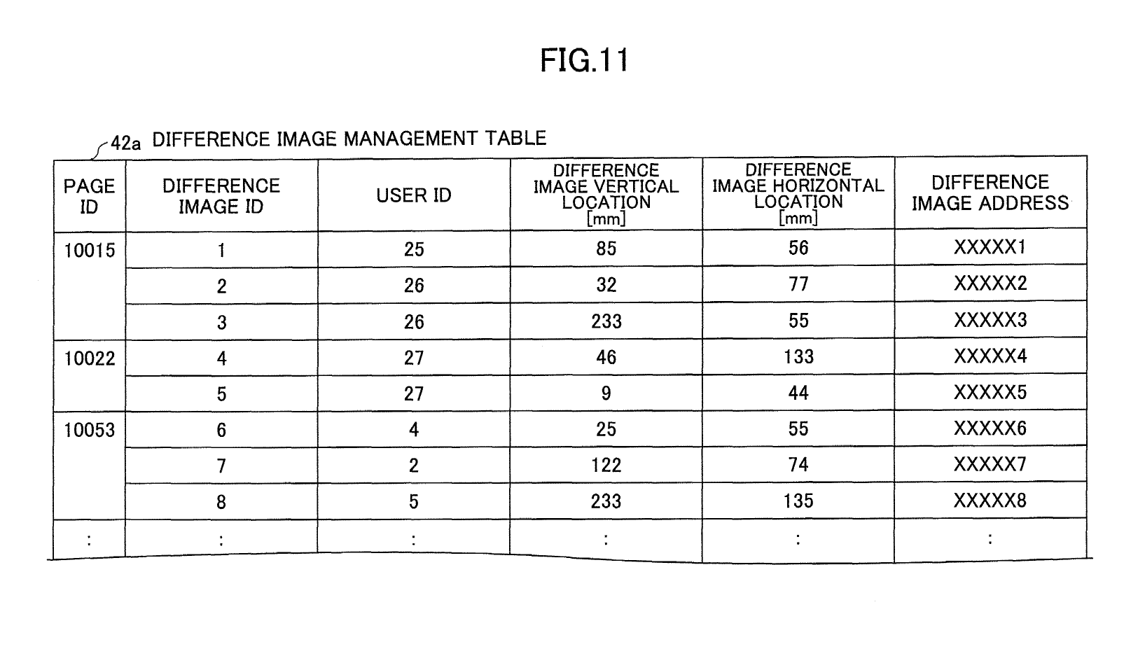

FIG. 11 is a diagram showing a second data structure of the difference image management table. In FIG. 11, the difference image management table 42a includes items of a page ID for identifying a page of the original 30 where the supplementary portion is added, a difference image ID for identifying the difference image 32, a user ID of a user who added the supplementary portion onto the original 30, a difference image vertical location, a difference image horizontal location, a difference image address, and a like. In the difference image management table 42a, instead of managing the difference images 32 by a combination of the document ID specifying the original 30 and the page number of the original 30, each of the difference images 32 is associated with the page ID which uniquely specifies each page.

For example, the difference image management table 42a is used to manage that the supplementary portions are added to pages specified by the page ID “10015”, “10022”, “10053”, and a like. Regarding the page of the page ID “10015”, the difference image 32 corresponding to one supplementary portion which a user of the user ID “25” added at this page is maintained by the difference image ID “1”, and the difference images 32 corresponding to two supplementary portions which a user of the user ID “26” added at this page is maintained by the difference image IDs “2” and “3”.

The difference image vertical location, the difference image horizontal location, and the difference image address of each difference image 32 are maintained similarly to the difference image management table 42 shown in FIG. 10, and the explanation thereof will be omitted.

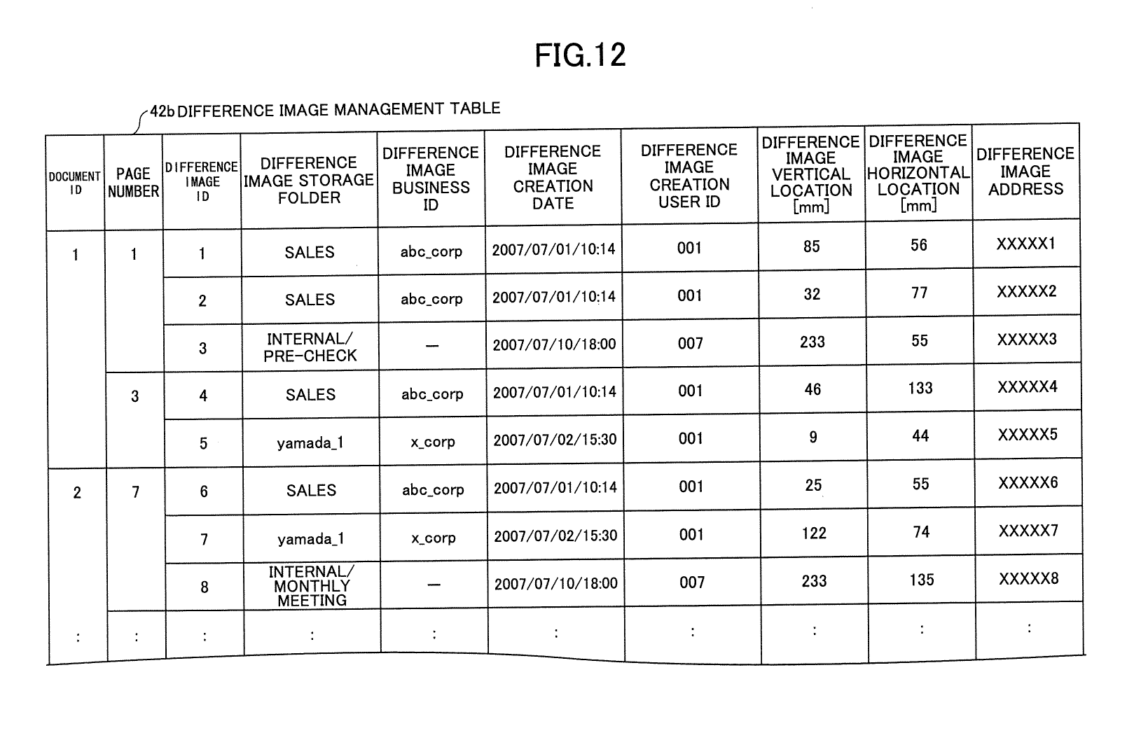

FIG. 12 is a diagram showing a third data structure of the difference image management table. In FIG. 12, the difference image management table 42b includes items of a document ID for specifying the original image 31 of the original 30, a page number of a page where the supplementary portion is added to the original 30, a difference image ID for identifying the difference image 32, a difference image storage folder indicating a folder name, which stores the difference image 32, a difference image business ID identifying a business to which the supplementary portion is subject, a difference image creation date indicating a data on which the difference image 32 was created, a difference image creation user ID identifying a user who added the supplementary portion, a difference image vertical location, a difference image horizontal location, a difference image address, and a like. In the difference image management table 42b, each of the difference images 32 is maintained by associating with the document ID and the page number. The difference image storage folder, the difference image business ID, the difference image creation date, the difference image creation user ID, and the like are maintained by corresponding to a respective difference image 32 as properties of the difference image 32.

The difference image storage folder is corresponded to the difference image 32 as the property. For example, the difference image 32 is classified into categories of “sales”, “in-office/pre-check”, “yamada_{—}1”, “in-office/monthly meeting”, and a like.

Moreover, the difference image business ID is corresponded to the difference image 32 as a property, and a customer ID may be applied as the difference image business ID. For example, the difference image 32 is classified into categories “abc_corp”, “x_corp”, and a like.

The difference image creation date is corresponded to the difference image 32 as a property, so that the difference image 32 is maintained in accordance with a progress in which the supplementary portions are added. For example, the difference image creation date is indicated in a format of “yyyy/mm/dd/hh:mm” (yyyy denotes year, mm denotes month, dd denotes date, and hh:mm denotes hour and minute).

Instead of setting items of the difference image storage folder, the difference image business ID, and the difference image creation date as the properties of the difference image 32, one of them or a combination of two of them may be set as properties.

The difference image vertical location, the difference image horizontal location, and the difference image address of each of the difference image 32 are maintained similarly to the difference image management table 42 shown in FIG. 10, and the explanation thereof will be omitted.

Various screen examples, at which a user composes the difference images 32 and the original image 31 after the difference images 32 are stored, will be described in the following.

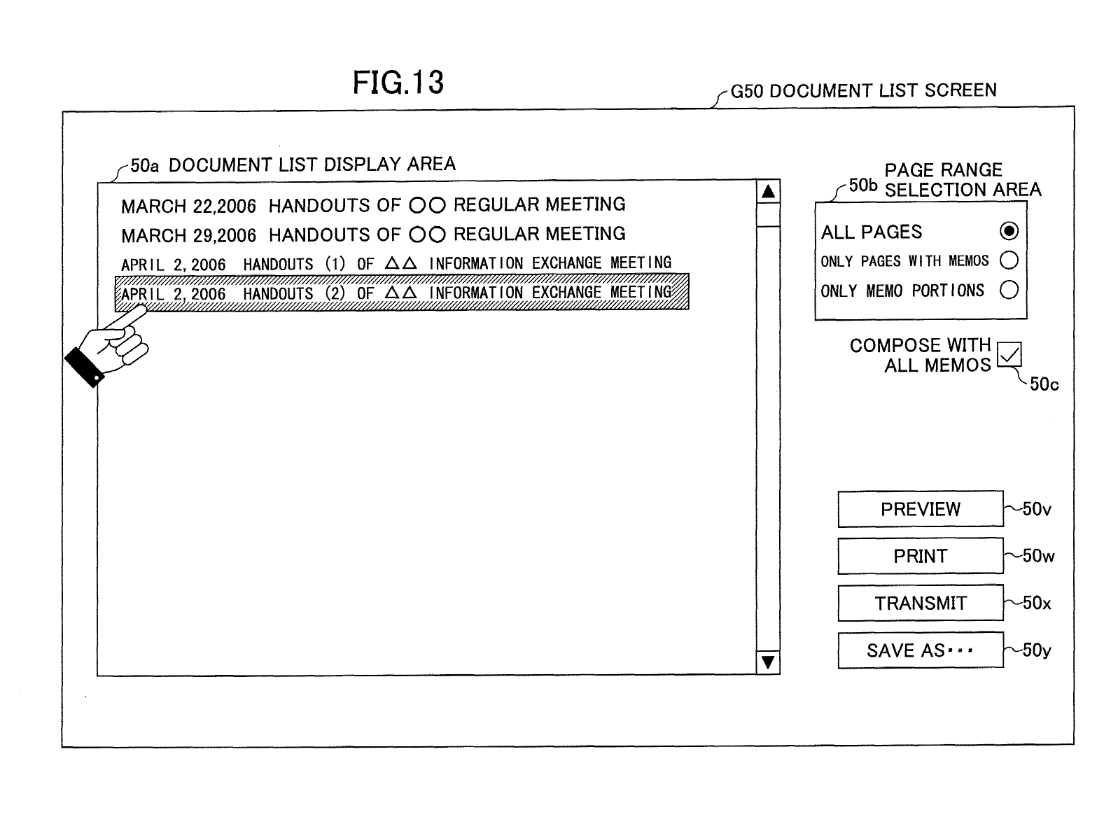

FIG. 13 is a diagram showing an example of a document list screen. A document list screen G50 shown in FIG. 13 includes a document list display area 50a that displays a list of documents managed as the original images 31 by the original management part 105, a page range selection area 50b for selecting a composition subject for the difference images 32, a check box 50c for composing all difference images 32 with the composition subject, a preview button 50v for previewing a document composed with the difference images 32, a print button 50w for printing out, a transmission button 50x for transmitting the document composed with the difference images 32 to a desired destination, a save button 50y for storing the document composed with the difference images 32 as another document, and a like.

For example, in the document list display area 50a, documents names are displayed such as “MARCH 22, 2006 HANDOUTS OF ◯◯ REGULAR MEETING”, “MARCH 29, 2006 HANDOUTS OF ◯◯ REGULAR MEETING”, “APRIL 2, 2006 HANDOUTS (1) OF ΔΔ INFORMATION EXCHANGE MEETING”, and “APRIL 2, 2006 HANDOUTS (2) OF ΔΔ INFORMATION EXCHANGE MEETING”.

The page range selection area 50b allows a user to make a check to one of “ALL PAGES”, “ONLY PAGES WITH MEMOS”, and “ONLY MEMO PORTIONS”.

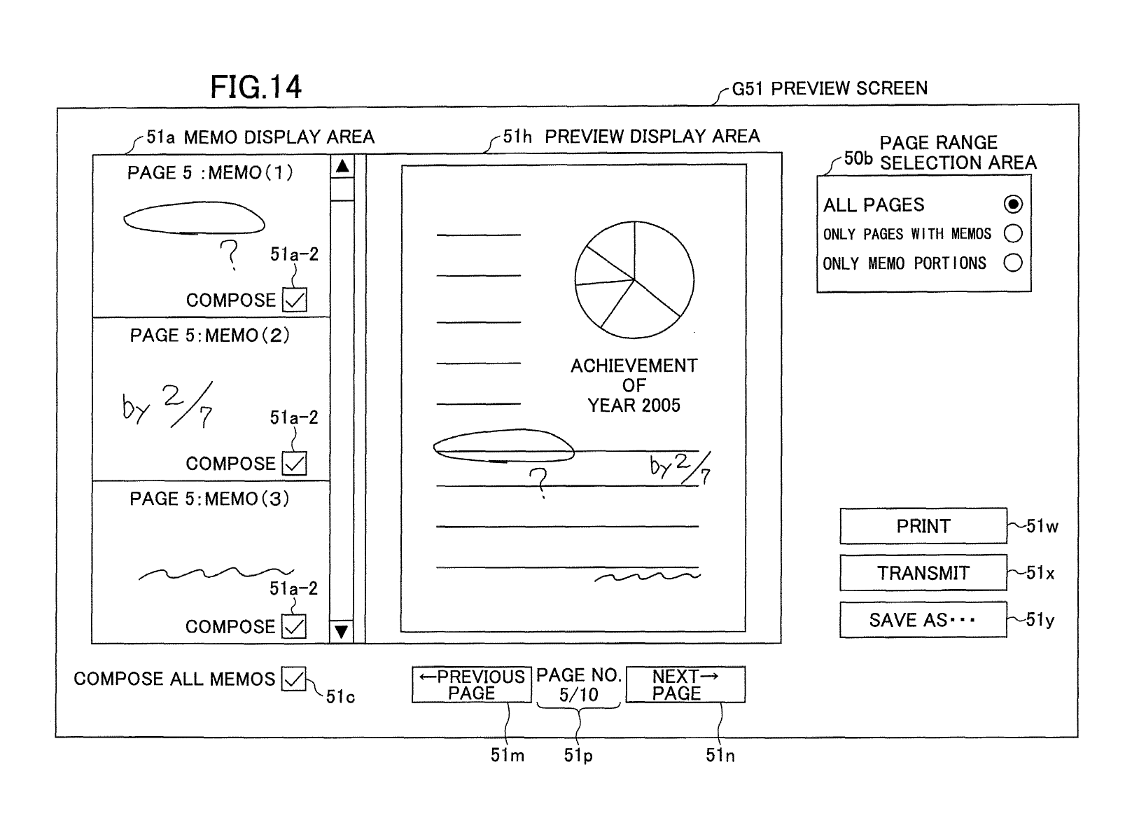

For example, when the user selects the document name “APRIL 2, 2006 HANDOUTS (2) OF ΔΔ INFORMATION EXCHANGE MEETING” from the document list display area 50a, selects “ALL PAGES” in the page range selection area 50b, makes a check in the check box 50c, and presses the preview button 50v, a preview screen G51 as shown in FIG. 14 is displayed at a display part 107b of the image processing apparatus 100 (or 100a) or at the UI 14 of the PC 10.

FIG. 14 is a diagram showing an example of the preview screen. The preview screen G51 shown in FIG. 14 includes a memo display area 51a that displays the difference images 32 as memos, a page range selection area 51b for selecting a page range subject to preview, a check box 51c for composing all difference images 32, a preview display area 51h, a previous page button 51m for displaying a previous page, a next page button 51n for displaying a next page, a display area 51p that displays a total count of all pages and a current page number, a print button 51w for printing out, a transmission button 51x for transmitting a document composed with the difference images 32 to a desired destination, a save button 51y for saving the document composed with the difference images 32 as another document, and a like.

The memo display area 51a includes a check area 51a-2 for selecting to compose for each difference image 32, so that a user is allowed to determine whether or not to compose for each difference image 32. If the user makes a check at the check box 51c to compose all difference images 32 to the composition subject, all check areas 51a-2 are automatically marked with respect to all difference images 32 displayed in the memo display area 51a.

The preview display area 51h displays a state of composing the original image 30 of the document selected by the user from the document list display area 50a of the document list screen G50 with the difference images 32 being checked in the check areas 51a-2 in the memo display area 51a.

The page range selection area 51b includes selection items of “ALL PAGES”, “ONLY PAGES WITH MEMOS”, “ONLY MEMO PORTIONS”, and a like. If the “ALL PAGES” is selected, all pages including pages to which a supplementary portion is not added (for example, pages at which there is no handwritten memo) are previewed and printed out in which each of pages having the supplementary portions is composed. If the “ONLY PAGES WITH MEMOS” is selected, only pages at which the supplementary portion is added (for example, pages at which there is a handwritten memo) are composed, displayed in the preview display area 51h, and printed out. If the “ONLY MEMO PORTIONS” is selected, the difference image 32 is composed with an image of a respective area at a page including the supplementary portion, displayed in the preview display area 51h, and printed out.

Every time the user operates the previous button 51m or the next page button 51n, the difference images 32 are displayed in the memo display area 51a by corresponding to a page. Simultaneously, the difference images 32 being displayed in the memo display area 51a are composed with the original image 30 at a respective page indicated by the operation of the user, and the respective page is displayed in the preview display area 51h.

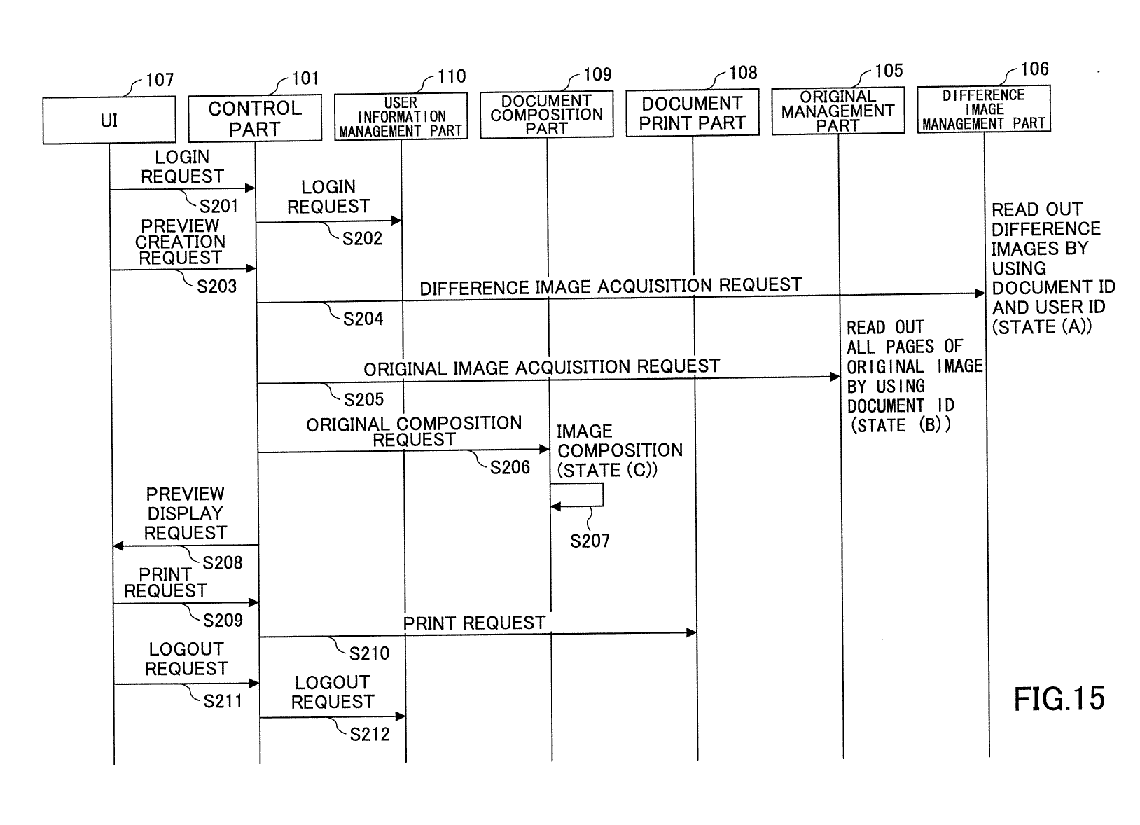

Next, sequences for composing the original image 31 with the difference images 32 will be described with reference to FIG. 15 through FIG. 24.

A sequence will be described with reference to FIG. 15 in a case of browsing and printing out all pages of a document with the supplementary portions (for example, handwritten memos) which a user added by himself or herself. FIG. 15 is a diagram for explaining the sequence in a case of displaying and printing out all pages including pages composed with the difference images. In FIG. 15, the sequence will be described in a case in that necessary processing parts are included in the image processing apparatus 100. Even if any one of the user information management part 110, the image composition part 109, the original management part 105, and the difference image management part 106 is provided to outside such as the server 200, the sequence is similarly described.

In FIG. 15, when a user logs in at the UI 107 of the image processing apparatus 100, the UI 107 sends a login request to the control part 101 (step S201), the control part 101 sends the login request to the user information management part 110 (step S202). In order to log in, the user may input a user ID or uses a card to input the user ID by a card reader at the UI 107.

When the user selects a desired document from the display list screen G50 displayed at the display part 107b after login, selects the “ALL PAGES”, and presses the preview button 50b, the UI 107 sends a preview creation request to the control part 101 (step S203).

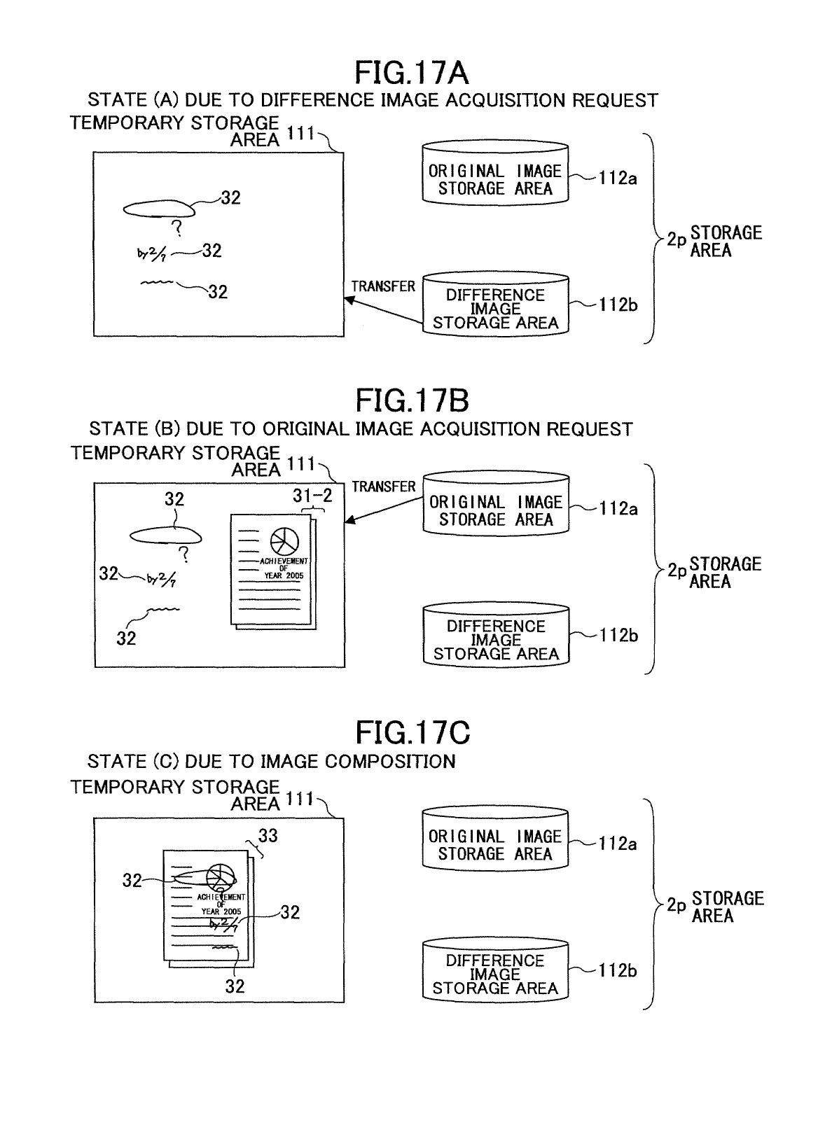

The control part 101 sends a difference image acquisition request indicating the document ID of the original image 31 corresponding to the document selected by the user and the user ID, to the difference image management part 106 in order to acquire the difference images 32 of memos which the user wrote by hand to the document (step S204). The difference image management part 106 refers the difference image management table 42b being stored in the storage area 2p, and reads out the difference images 32 of the user by using the document ID and the user ID (STATE (A) shown in FIG. 17A).

Next, the control part 101 sends an original image acquisition request indicating the document ID and the “ALL PAGES” to the original management part 105 in order to acquire the original image 31 of the document selected by the user (step S205). The original management part 105 reads out the original image 31 from the storage area 2p by using the document ID and stores the original image 31 in the temporary storage area 111 (STATE (B) shown in FIG. 17B).

Furthermore, the control part 101 sends an image composition request to the image composition part 109 in order to compose the difference images 32 of memos of the user with the original image 31 (step S206). The image composition part 109 conducts an image composition for composing the original image 31 and the difference image 32 (STATE (C) shown in FIG. 17C) (step S207).

After that, the control part 101 sends a preview display request to the UI 107 to display the preview screen G51 for previewing “ALL PAGES” by using composed images at the display 107b (step S208).

The user presses the print button 51w to print out “ALL PAGES”, after the user confirms the original image 31 being composed with the difference images 32. The UI 107 sends a print request for printing out the document to the control part 101 (step S209). Then, the control part 101 sends the print request to the document print part 108 (step S210).

When the user logs out after printing out the document, the UI 107 sends a logout request to the control part 101 (step S211). The control part 101 sends the log out request to the user information management part 110 (step S212).

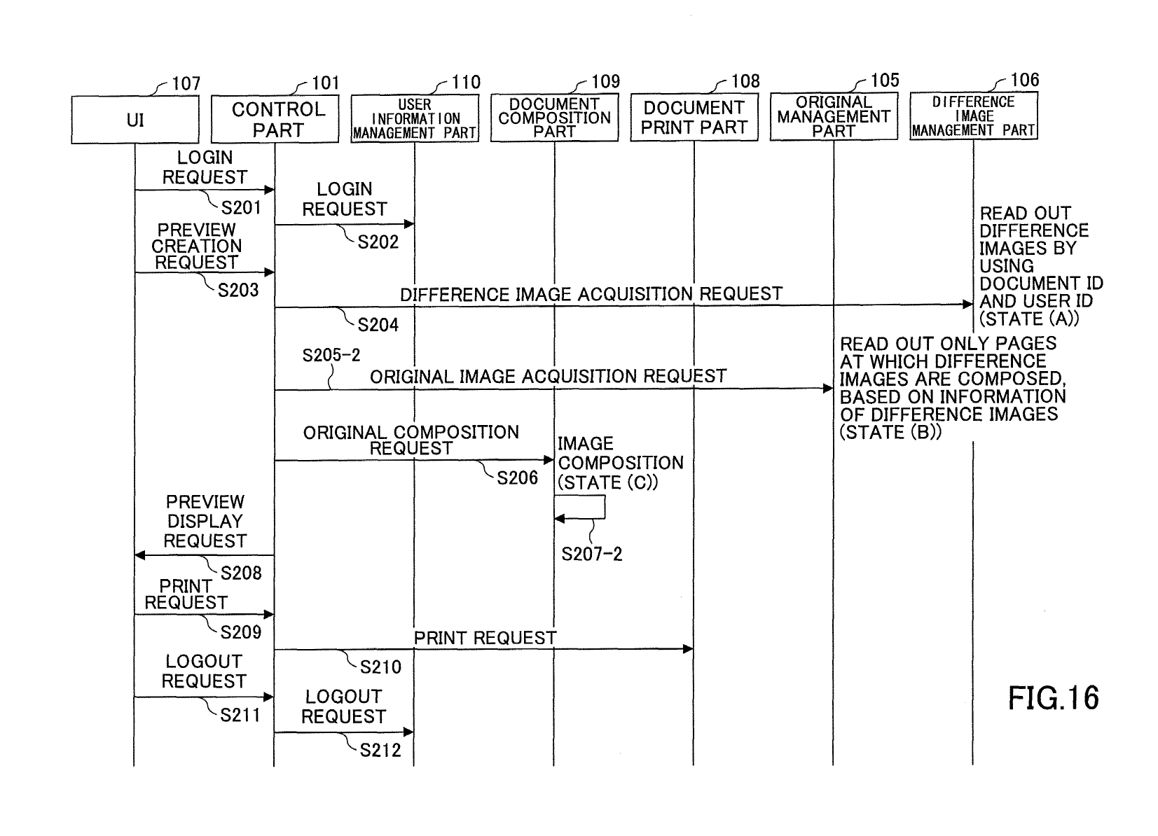

A sequence in a case of browsing and printing out only pages to which the user made memos by hand will be described with reference to FIG. 16. FIG. 16 is a diagram for explaining the sequence in the case of browsing and printing out only pages to which the user wrote memos by hand and which are composed with the difference images 32. In FIG. 16, the sequence will be described in that the processing parts 101, 105, 106, 107, 108, 109, and 110 are included in the image processing apparatus 100. Even in a case in that one or more of the user information management part 110, the image composition part 109, the original management part 105, and the difference image management part 106 are included in the server 200, the same sequence can be conducted. Also, in FIG. 16, steps that are the same as the ones in FIG. 15 are indicated by the same reference numerals and the explanation thereof will be omitted.

In FIG. 16, after the user logs in (steps S201 and S202), when the user selects a desired document at the document list screen G50 displayed at the display part 107b, selects the “ONLY PAGES WITH MEMO”, and presses the preview button 50b, the UI 107 sends a preview creation request to the control part 101 (step S203).

The control part 101 reads out the difference images 32 from the temporary storage area 111 by sending a difference image acquisition request indicating the document ID and the user ID to the difference image management part 106 (STATE (A) shown in FIG. 17A) (step S204).

After that, the control part 101 sends an original image acquisition request indicating the document ID and the “ONLY PAGES WITH MEMO” to the original management part 105 to acquire the original image 31 of the document selected by the user (step S205-2). The original management part 105 acquires a page number of which page is composed with the difference images 32, for example, by referring the difference image management table 42, 42a, or 42b, based on information of each of the difference images 32 being stored in the temporary storage area 111. Then, the original management part 105 specifies the original image 31, which is stored in the storage area 2p, corresponding to the page number of the document identified by the document ID, and stores the original image 31 of the page number in the temporary storage area 111 (STATE (B) shown in FIG. 17B).

Moreover, the control part 101 sends an image composition request to the image composition part 109 to compose the difference images 32 of memos of the user with the original image 31 (step S206). The image composition part 109 conducts an image composition that composes the difference images 32 and the original image 31, by corresponding to the page number of each of the difference images 32 and that of the original image 31 (STATE (C) shown in FIG. 17C) (step S207-2).

After that, the user confirms the original image 31 being composed with the difference images 32 on the preview screen G51 displayed at the display part 107b and prints out only pages with memos (steps S208 through S210), and logs out (steps S211 and S212).

States of the image composition for composing the original image 31 and the difference images 32 will be described in the following. In FIG. 17A, FIG. 17B, and FIG. 17C, an original image storage area 112a and a difference image storage area 112b are partial areas in the storage area 2p. The original image storage area 112a is an area which is managed by the original management part 105 and is used to store the original image 31. The difference image storage area 112b is an area which is managed by the difference image management part 106 and is used to store the difference images 32.

FIG. 17A is a diagram showing the STATE (A) due to the difference image acquisition request in FIG. 15 and FIG. 16. In FIG. 17A, the difference image management part 106 acquires each address of the difference images 32 from the difference image management table 42 or 42b by using the document ID and the user ID, reads out the difference images 32 from the difference image storage area 112b, and transfers the difference images 32 to the temporary storage area 111.

FIG. 17B is a diagram showing the STATE (B) due to the original image acquisition request in FIG. 15 and FIG. 16. In FIG. 17B, when the “ALL PAGES” is indicated by the original image acquisition request, the original management part 105 reads out the original image 31 for all pages of the document from the original image storage area 112a by using the document ID, and transfers the original image 31 to the temporary storage area 111.

When the “ONLY PAGES WITH MEMOS” is indicated by the original image acquisition request, the original management part 105 specifies respective pages from information of the difference images 32 stored in the temporary storage area 111, reads out the original image 31 for the respective pages, and transfers the original image 31 to the temporary storage area 111.

FIG. 17C is a diagram showing the STATE (C) due to the image composition in FIG. 15 and FIG. 16. In FIG. 17C, the image composition part 109 generates a composed image 33 by composing the original image 31 and the difference images 32, which are stored in the temporary storage area 111.

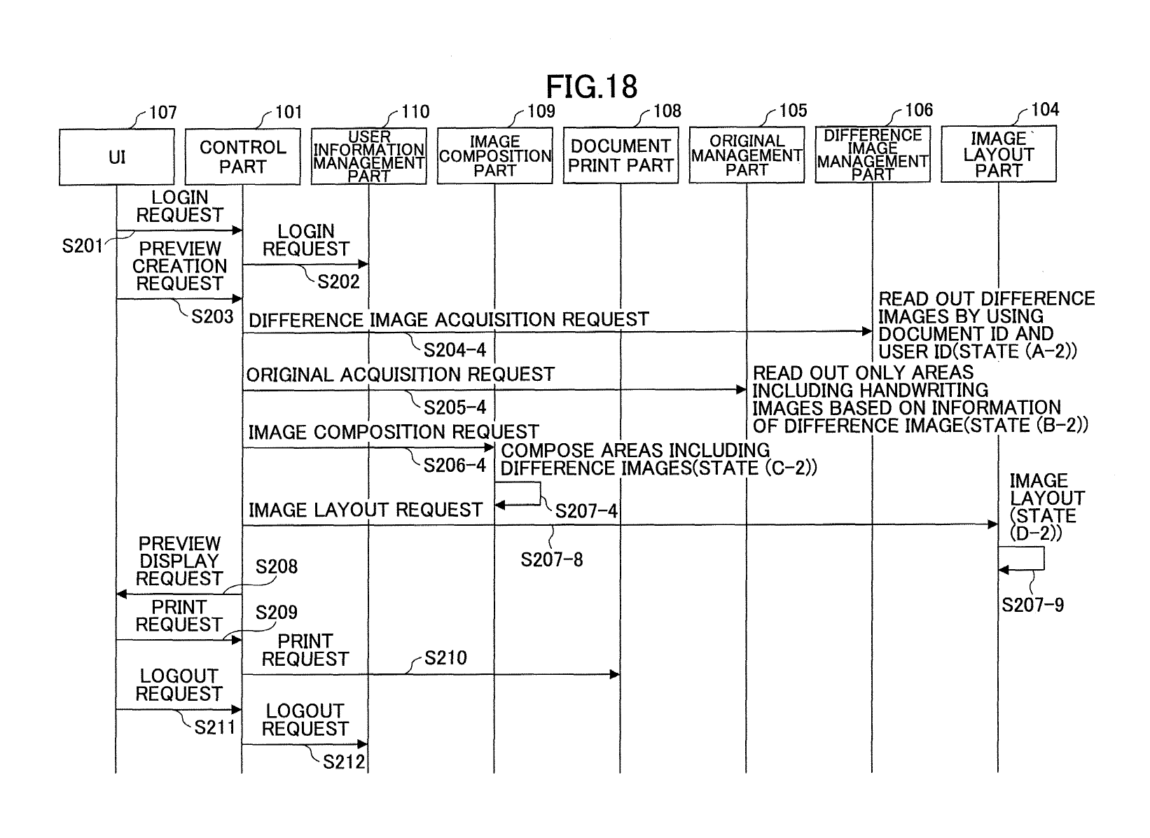

A sequence in a case in that the user displays and prints out only areas where memos are handwritten by the user will be described with reference to FIG. 18. FIG. 18 is a diagram for explaining the sequence in a case of composing the difference images 32 of handwritten memos of the user with areas including the difference images 32 in the original image 31 to display and print out. In FIG. 18, the sequence will be described in that the processing parts 101, 104, 105, 106, 107, 108, 109, and 110 are included in the image processing apparatus 100. Even in a case in that one or more of the user information management part 110, the image composition part 109, the original management part 105, and the difference image management part 106 are included in the server 200, the same sequence can be conducted. Also, in FIG. 18, steps that are the same as the ones in FIG. 15 are indicated by the same reference numerals and the explanation thereof will be omitted.

In FIG. 18, after the user logs in (steps S201 and S202), the user selects a desired document on the document list screen G50 displayed at display part 107b, selects the “ONLY MEMO PORTIONS”, and presses the preview button 50v, the UI 107 sends a preview creation request to the control part 101 (step S203).

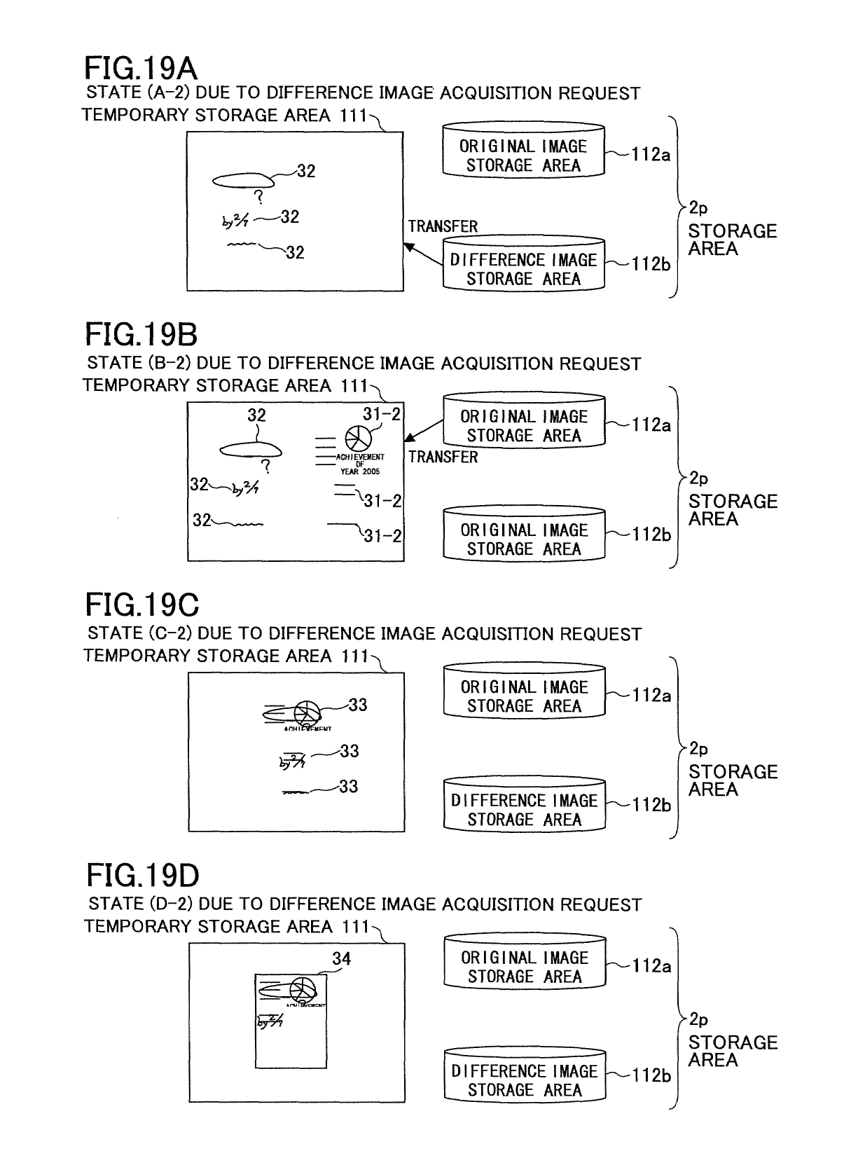

The control part 101 reads out the difference images 32 from the temporary storage area 111 by sending a difference image acquisition request indicating the document ID and the user ID to the difference image management part 106 (STATE (A-2) shown in FIG. 19A) (step S204-4).

After that, the control part 101 sends an original image acquisition request indicating the document ID and the “ONLY MEMO PORTIONS” to acquire the original image 31 of the document selected by the user (step S205-4). The original management part 105 acquires each of respective areas in the original image 31 for the difference images 32, based on information of the difference images 32 stored in the temporary storage area 111, and stores the respective areas in the temporary storage area 111 (STATE (B-2) shown in FIG. 19B).

Next, the control part 101 sends an image composition request to the image composition part 109 to compose the difference images 32 of handwritten memos of the user with the respective areas including the difference images 32 (step S206-4). The image composition part 109 generates images in which the difference images 32 stored in the temporary storage area 111 is composed with the respective areas including the difference images 32 in the original image 31, and stores the generated images in the temporary storage area 111 (STATE (C-2) shown in FIG. 19C) (step S207-4).

Subsequently, the control part 101 sends an image layout request to the image layout part 104 to layout the respective areas including the difference images 32 (step S207-8). The image layout part 104 layouts the composed images by meeting to the size of a sheet to be printed (STATE (D-2) shown in FIG. 19D).

After that, the user confirms the original image 31 being composed with the difference images 32 on the preview screen G51 displayed at the display part 107b and prints out the original image 31 (steps S208 through S210). Then, the user logs out (steps S211 and S212).

States of the image composition for composing the difference images 32 and the respective areas including the difference images 32 in the original image 31 will be described with reference to FIG. 19A, FIG. 19B, FIG. 19C, and FIG. 19D.

FIG. 19A is a diagram showing the STATE (A-2) due to the difference image acquisition request in FIG. 18. In FIG. 19, the difference image management part 106 acquires each address of the difference images 32 from the difference image management table 42 or 42b by using the document ID and the user ID, reads out the difference images 32 from the difference image storage area 112b, and transfers the difference images 32 to the temporary storage area 111.

FIG. 19B is a diagram showing the STATE (B-2) due to the original image acquisition request in FIG. 18. In FIG. 19B, when the “ONLY MEMO PORTIONS” is indicated by the original image acquisition request, the original management part 105 specifies respective pages to the difference images 32 from information of the differences images 32 which are stored in the temporary storage area 111 as shown in FIG. 19A. Based on location information indicating the difference image vertical location and the difference image horizontal location which are indicated in the information of the difference images 32, areas 31-2 including the difference images 32 from the original image 31 at specified pages are read out and transferred to the temporary storage area 111.

The temporary storage area 111 stores the difference images 32 and the areas 31-2 extracted from the original image 31 and including the difference images 32. A relationship between the difference images 32 and the areas 31-2 is managed by the control part 101.

FIG. 19C is a diagram showing the STATE (C-2) due to the image composition in FIG. 18. In FIG. 19C, the image composition part 109 composes the difference images 32 with the areas 31-2 extracting from the original image 31 and including the difference images 32, and stores composed images 33-2 in the temporary storage area 111.

FIG. 19D is a diagram showing the STATE (C-2) due to the image layout request in FIG. 18. In FIG. 19D, the image layout part 104 generates a composed layout image 34 so that the composed images 33-2 stored in the temporary storage area 111 are arranged and adjusted to the size of a sheet to be printed.

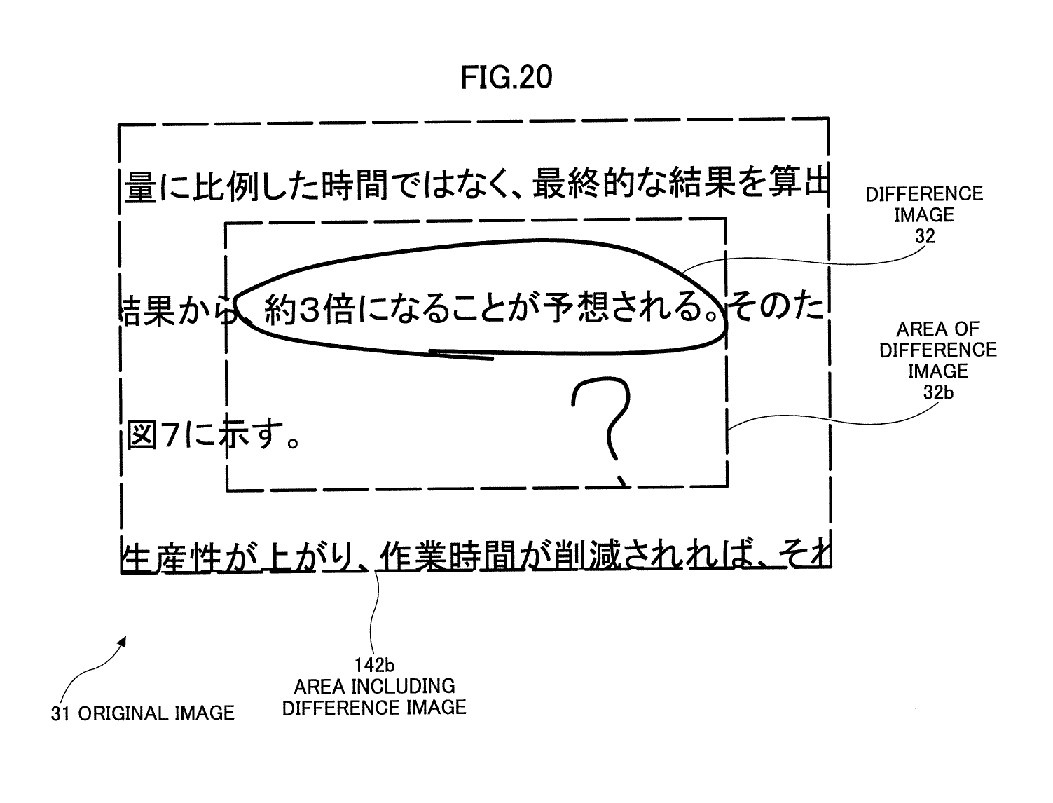

FIG. 20 is a diagram for explaining an area including the difference image 32. As shown in FIG. 20, an area 142b including the difference image 32 is an area defined so as to include a peripheral image formed by predetermined margins in vertical and horizontal with respect to an area 32b of the difference image 32. The area 142b including the difference image 32 is read out from the original image 31 at a page where the difference image 32 is composed.

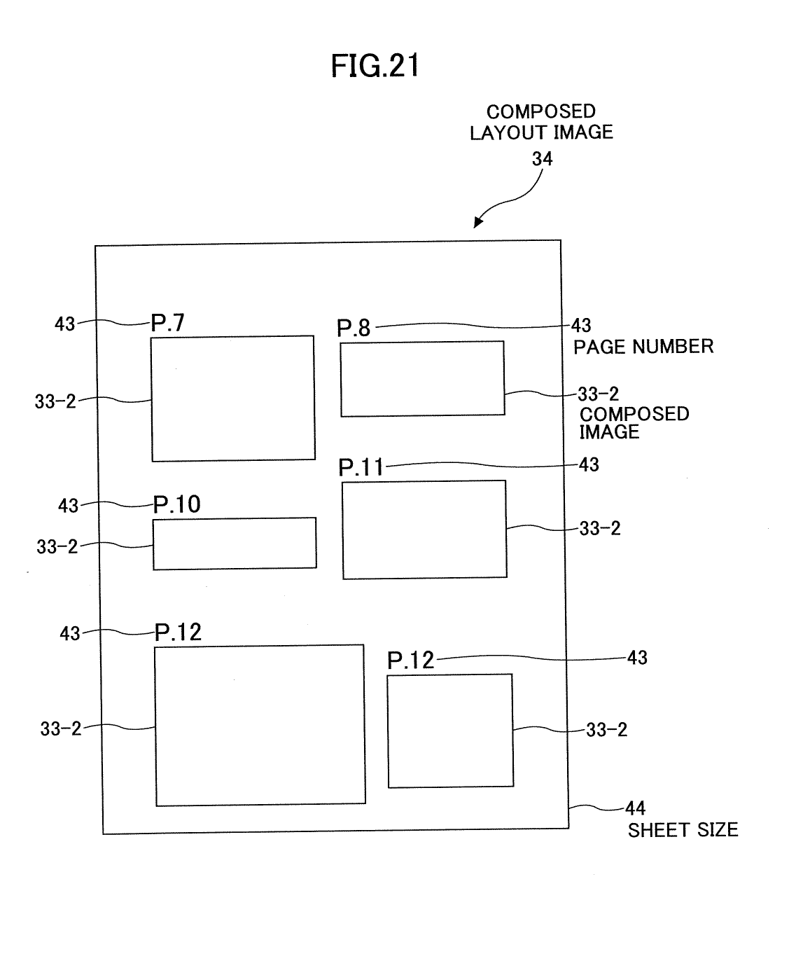

An example of the composed layout image 34 created by the image layout part 104 will be described with reference to FIG. 21. FIG. 21 is a diagram showing the example of the composed layout image 34. In the composed layout image 34 shown in FIG. 21, based on each size of the composed images 33-2 to be printed out, one or more composed images 33-2 are arranged in a sequence of a page number in a sheet size 44. A page number 43 is provided for each of the composed images 33-2.

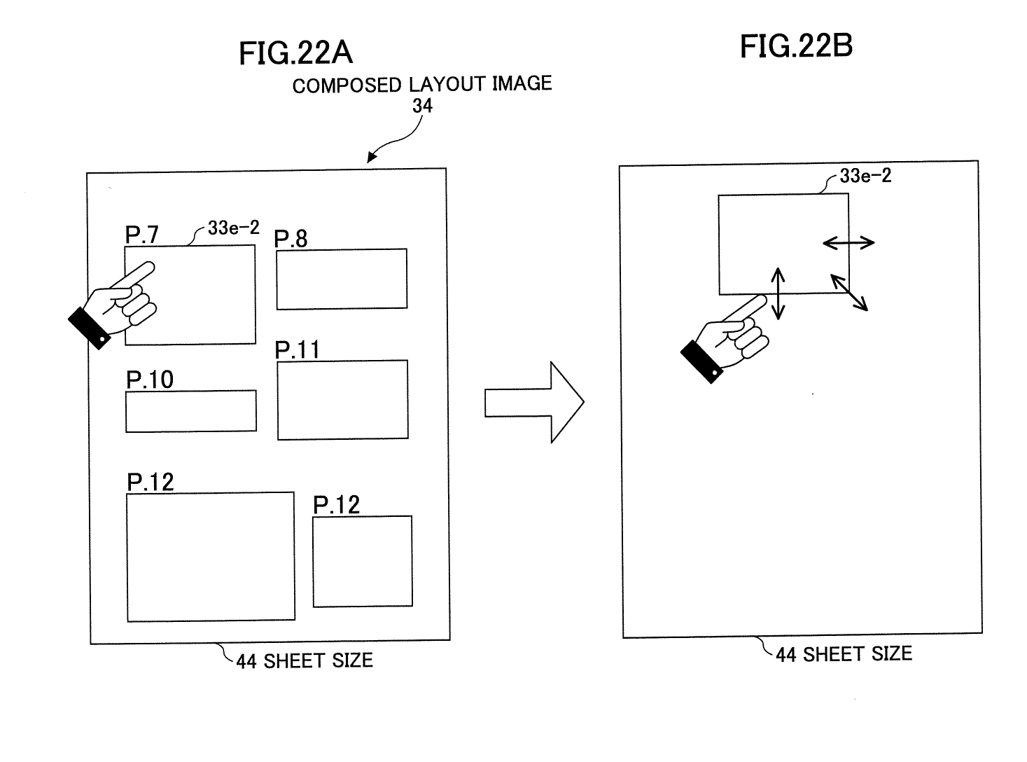

The composed layout image 34 is displayed at display part 107, and the user is allowed to freely change each size of the composed images 33-2. An operation example for the user to change the size of the composed image 33-2 will be described with reference to FIG. 22A and FIG. 22B.

In FIG. 22A, when the user selects a composed image 33e-2 of the supplementary portion (for example, a handwritten portion) of “P.7” laid out adjusting in the sheet size to print on the composed layout image 34, only the composed image 33e-2 selected by the user is displayed within the sheet size 44 to print, as shown in FIG. 22B.

In FIG. 22B, the user is allowed freely set a height and a width of the composed image 33e-2 by dragging one side or corner of the composed image 33e-2. When a size of the composed image 33e-2 is changed, the image layout part 104 conducts a layout process, again.

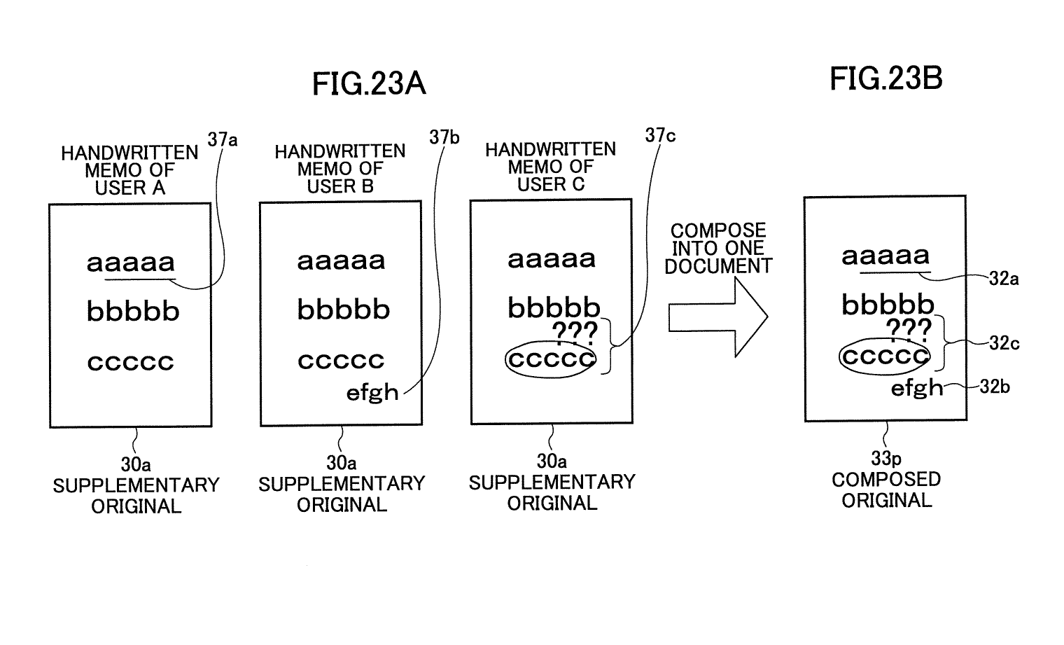

A case for one user to compose and browse handwritten memos of a plurality of users into a single document will be described with reference to FIG. 23A and FIG. 23B. In FIG. 15 and FIG. 16, when the user indicates all users as display subjects for handwritten memos after login, the document ID and “ALL USERS” is indicated in the difference image acquisition request in step S204. Similarly, in step S204-4 in FIG. 18, the document ID and “ALL USERS” is indicated in the difference image acquisition request.

For example, in a case of composing, into a single document, a handwritten memo 37a of a user A, a handwritten memo 37b of a user B, and a handwritten memo 37c of a user C which are added respectively at the same page of the supplementary originals 30a as shown in FIG. 23A, a composed image 33p is generated as shown in FIG. 23B so that a difference image 32a of the handwritten memo 37a of the user A, a difference image 32b of the handwritten memo 37b of the user B, and a difference image 32c of the handwritten memo 37c of the user C are composed with the original image 31 of the page.

The composed image 33p is displayed in the preview display area 51h of the preview screen G51 shown in FIG. 14. Thus, the user can refer to a state of integrating the handwritten memos 37a, 37b, and 37c added by the plurality of users A, B, and C. In a case of displaying the composed image 33p in the preview display area 51h and printing out the composed image 33p, the handwritten memos 37a through 37c may be displayed with different colors respective to the users A through C.

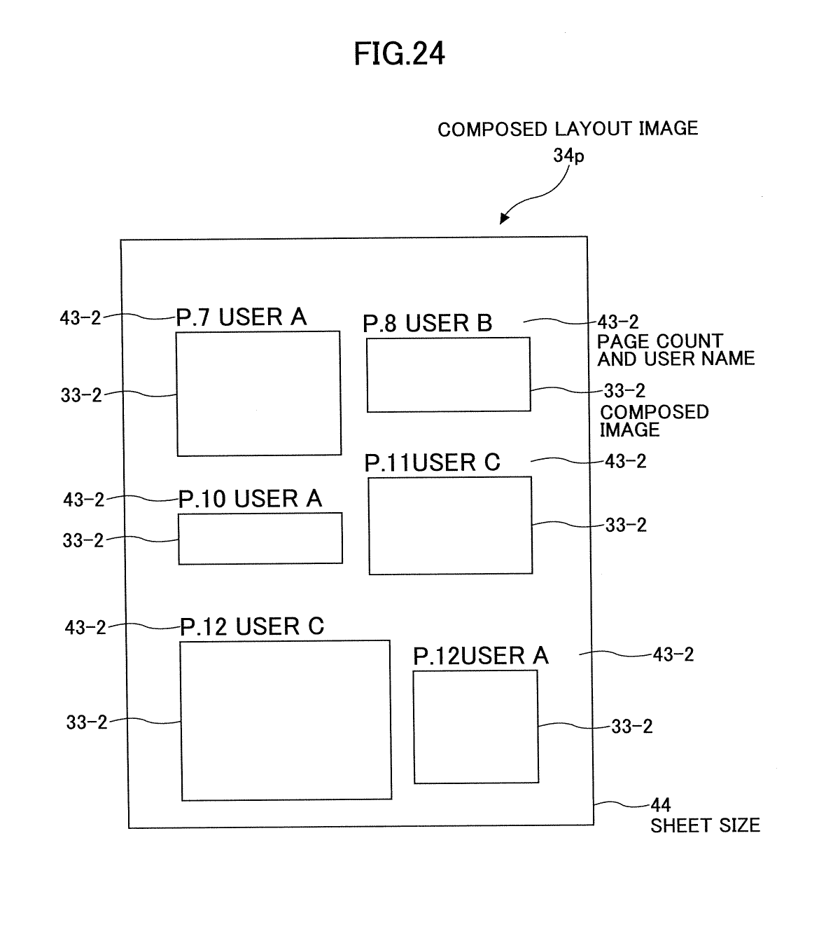

FIG. 24 is a diagram showing an example of the composed layout image in which only handwritten memos made by the plurality users are laid out. In the composed layout image 34p shown in FIG. 24, based on the size of the composed images 33-2, one or more composed images 33-2 are arranged in a page sequence in the sheet size 44, and a page count and user name 43-2 is provided for each of the composed images 33-2.

As described above, the difference image 32 is acquired by comparing the original image 31 and the supplementary original image showing that handwritten memos are added on the original 30, and the original image 31 and the difference image 32 are separately maintained.

By using the difference image management table 42, 42a, or 42b, it is possible to display only pages at which the handwritten memos are added, at the display part 107b. Moreover, it is possible to automatically arrange and display only areas where the handwritten memos exist, at the display part 107.

Moreover, it is possible for the user to change an image size of a composed image 33 selected from a plurality of the composed images 33. Furthermore, it is possible to compose and display the handwritten memos of a plurality of users into one document at the display part 107b.

A case of indicating a composed subject by using the properties of the difference images 32 managed in the difference image management table 42b will be described in the following.

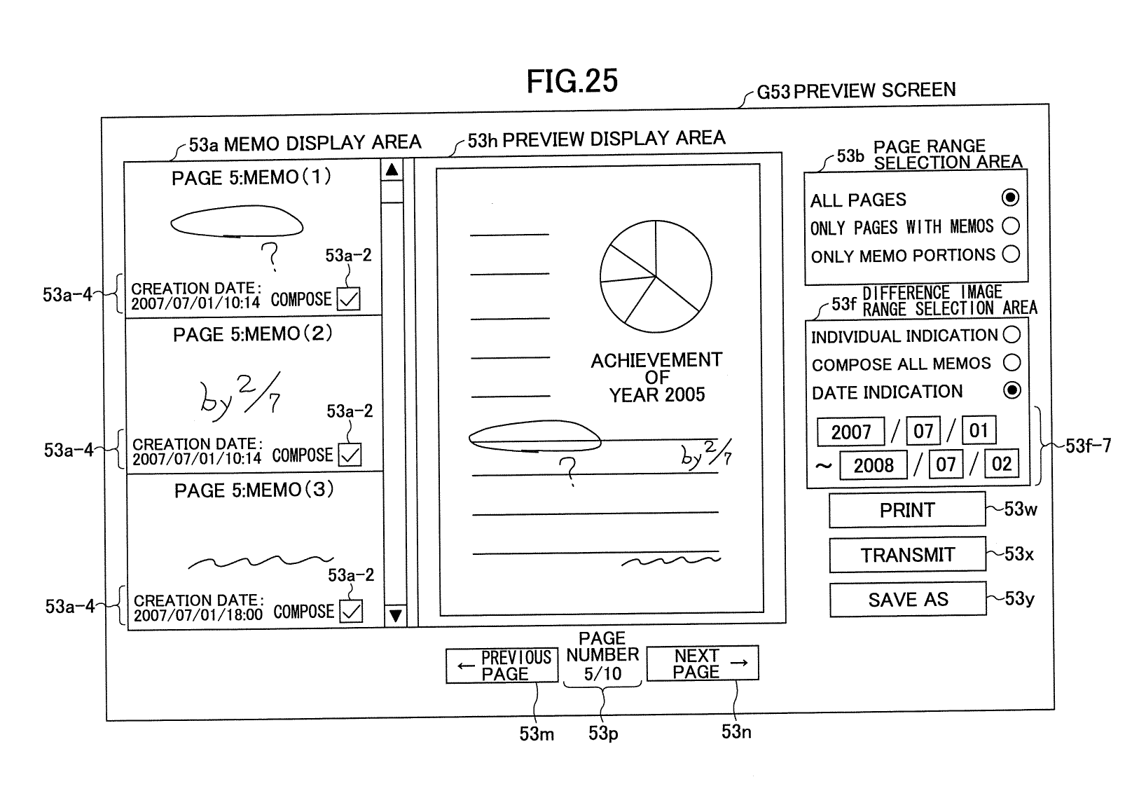

A case of utilizing the difference image creation data of the difference image management table 42b will be described. FIG. 25 is a diagram showing an example of a preview screen allowing indication of a range of the composed subject by the difference image creation date. On the document list screen G50 shown in FIG. 13, when the user selects one document from the document list display area 50a and presses the preview button 50v, a preview screen G53 in FIG. 25 is displayed at the display part 107b of the image processing apparatus 100 (or 100a) or the UI 14 of the PC 10.

The preview screen G53 shown in FIG. 25 includes a memo display area 53a that displays the difference images 32 as memos, a page range selection area 53b for selecting a page range subject to preview, a difference image range selection area 53f for selecting the difference images 32 as composition subjects, a preview display area 53h, a previous page button 53m for displaying a previous page, a next page button 53n for displaying a next page, a display area 53p that displays a total page count and a current page count, a print button 53w for printing out, a transmission button 53x for transmitting a document being composed with the difference images 32 to a desired destination, a save button 53y for save the document being composed with the difference images 32 as another document, and a like.

The memo display area 53a includes a check area 53a-2 for selecting to compose for each difference image 32, and a creation date 53a-4 showing a date for each difference image 32 when the difference image 32 was created. Each check area 53a-2 allows a user to determine whether or not to compose for each difference image 32. A selection at the check area 53a-2 is enabled based on whether the user makes a check at the difference image range selection area 53f. Moreover, the creation date 53a-4 corresponds to the difference image creation date as the property of the difference image 32 being managed by the difference image management table 42b.

The difference image range selection area 53f includes selection items of “INDIVIDUAL INDICATION”, “COMPOSE ALL MEMOS”, “DATE INDICATION”, and a like. When “INDIVIDUAL INDICATION” is selected, each check made at the check areas 53a-2 on the memo display area 53a is enabled. When “COMPOSE ALL MEMOS” is selected, all difference images 32 displayed in the memo display area 53a are the composition subjects. When “DATE INDICATION” is selected, a date setting area 53f-7 is enabled to set a date range. Then, the user sets dates in the date setting area 53f-7.

The page range selection area 53b, the preview display area 53h, the previous button 53m, the next button 53n, the display area 53p, the print button 53w, the transmission button 53x, and the save button 53y are the same as the page range selection area 51b, the preview display area 51h, the previous button 51m, the next page button 51n, the display area 51p, the print button 51w, the transmission button 51x, and the save button 51y, and the explanation thereof will be omitted.

Accordingly, it is possible for a user to display a state at a date when the supplementary portions such as the handwritten memos are added, by indicating the date range of the composition subjects at the preview screen G53. For example, after a meeting was conducted using the same document at several times, it is possible to preview the handwritten memos as the composition subjects for every meeting, and it is possible to comprehend a proceeding at every meeting.

Moreover, in a case of creating a document by hand, the difference image creation date can be used as an update history. It is possible to confirm when and how the document is created.

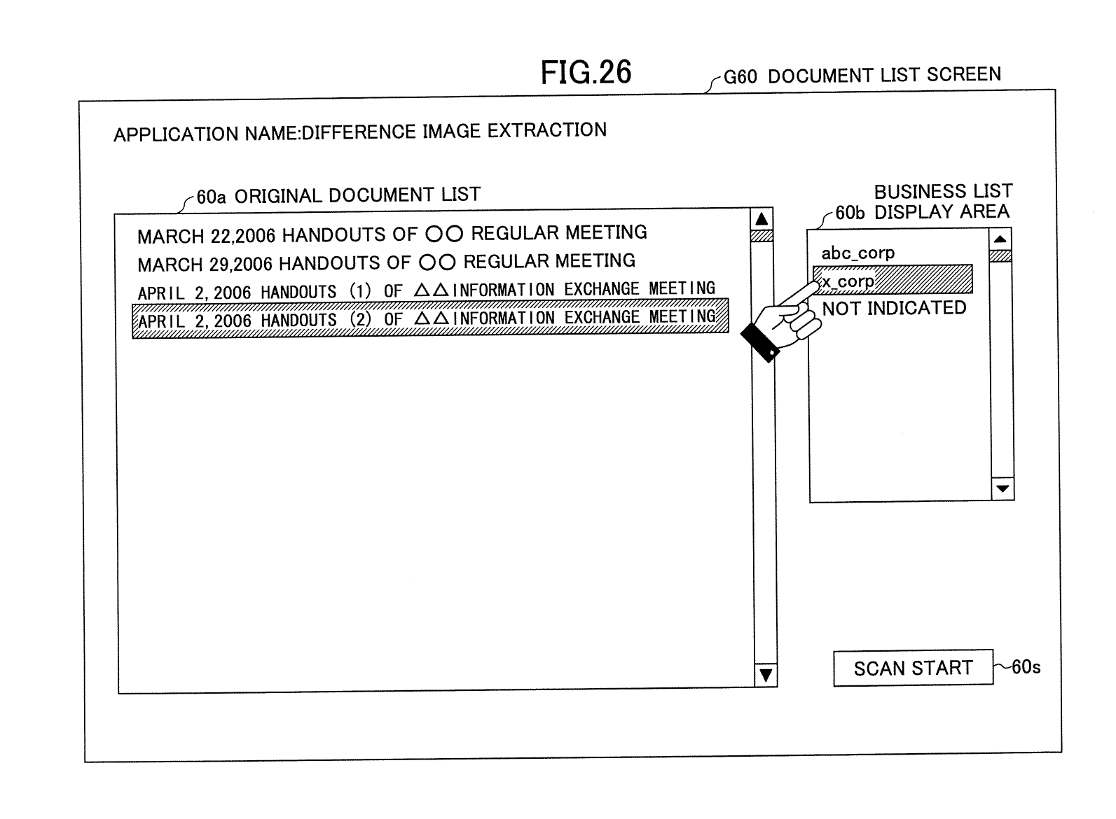

A case of using the difference image business ID of the difference image management table 42b will be described. FIG. 26 is a diagram showing an example of the document list screen for extracting the difference images 32 regarding an indicated business. The document list screen G60 shown in FIG. 26 includes a document list display area 60a that displays a list of documents managed as the original image 31 by the original management part 105, a business list display area 60b that displays a business list from which one business can be selected, and a scan start button 60s for scanning the supplementary original 30a and extracting the difference images 32.

The user selects an original document name corresponding to the original 30, to which no supplementary portion such as a handwritten portion is added, from the document list display area 60a, and selects a business (for example, a customer name) for which the supplementary portions are subject, from the business list display area 60b. Then, the user presses the scan start button 60s. The supplementary original 30a to which the supplementary portions are added is scanned, and an extraction process of the difference images 32 is conducted by using the original image 31 of the original 30 selected by the user.

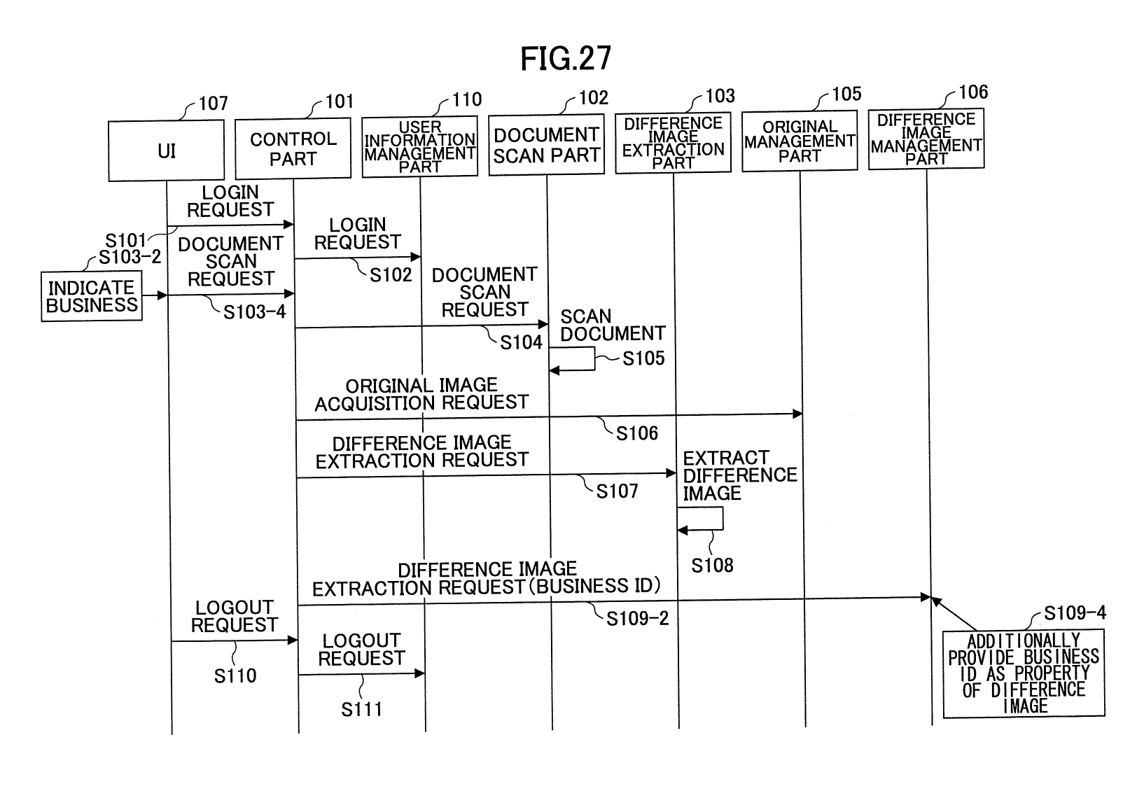

FIG. 27 is a diagram for explaining a sequence for relating the difference images 32 extracted by scanning the supplementary original to the business. In FIG. 27, steps that are the same as the ones in FIG. 7 are indicated by the same reference numerals and the explanation thereof will be omitted. It does not matter if the processing parts 103, 105, 106, and 110 are provided internally to or externally from the image processing apparatus 10a. Even in a case in that the processing parts 103, 105, 106, and 110 are accessed from the network 2, the sequence is the same, and a communication sequence through the network 2 is omitted in FIG. 27.

In FIG. 27, after login (steps S101 and S102), the control part 101 acquires information necessary to configure the document list screen G60 shown in FIG. 26 from a predetermined storage area.

For example, the document name and the document ID of the original image 31 of the original 30 are maintained by the original management part 105, and the control part 101 acquires a list of the document names and the document IDs from the original management part 105 to display the document names in the document list display area 60a. In a case of associating the document name and the document ID with the user ID, the control part 101 may inquire the original management part 105 by using the user ID.

Moreover, in a case in that the business and business ID are managed by the user information management part 110, the control part 101 acquires the business and business ID from the user information management part 110 to display a list of business names in the business list display area 60b. In a case of associating the business and the business ID with the user ID, the control part 101 may inquire the user information management part 110 by using the user ID. A customer name and a customer ID as may be applied as the business and the business ID, respectively.

When the user selects the business from the document list screen G60 shown in FIG. 26 and indicates a scan start (step S103-2), the UI 107 sends a document scan request to the control part 101 (step S103-4). The control part 101 instructs the document scan part 102 to scan the supplementary original 30a (steps S104 and S105), acquires the original image 31 corresponding to the document name which the user selects from the document list screen G60 shown in FIG. 26, from the original management part 105 (step S106), and instructs the difference image extraction part 103 to extract the difference images 32 (steps S107 and S108).

The control part 101 sends a difference image store request to the difference image storage part 106 to store the difference images 32 extracted by the difference image extraction part 103 (step S109-2). The difference image store request includes the document ID, the page number, the business ID, the difference images 32 extracted by the difference image extraction part 103.

The difference image management part 106 additionally provides a difference image ID to each of the difference images 32 and stores the difference images 32 in the storage area 2p in response to the difference image storage request (step S109-4). In this case, the difference image storage folder, the difference image creation date, and the difference image creation user ID can be omitted in the difference image store request.

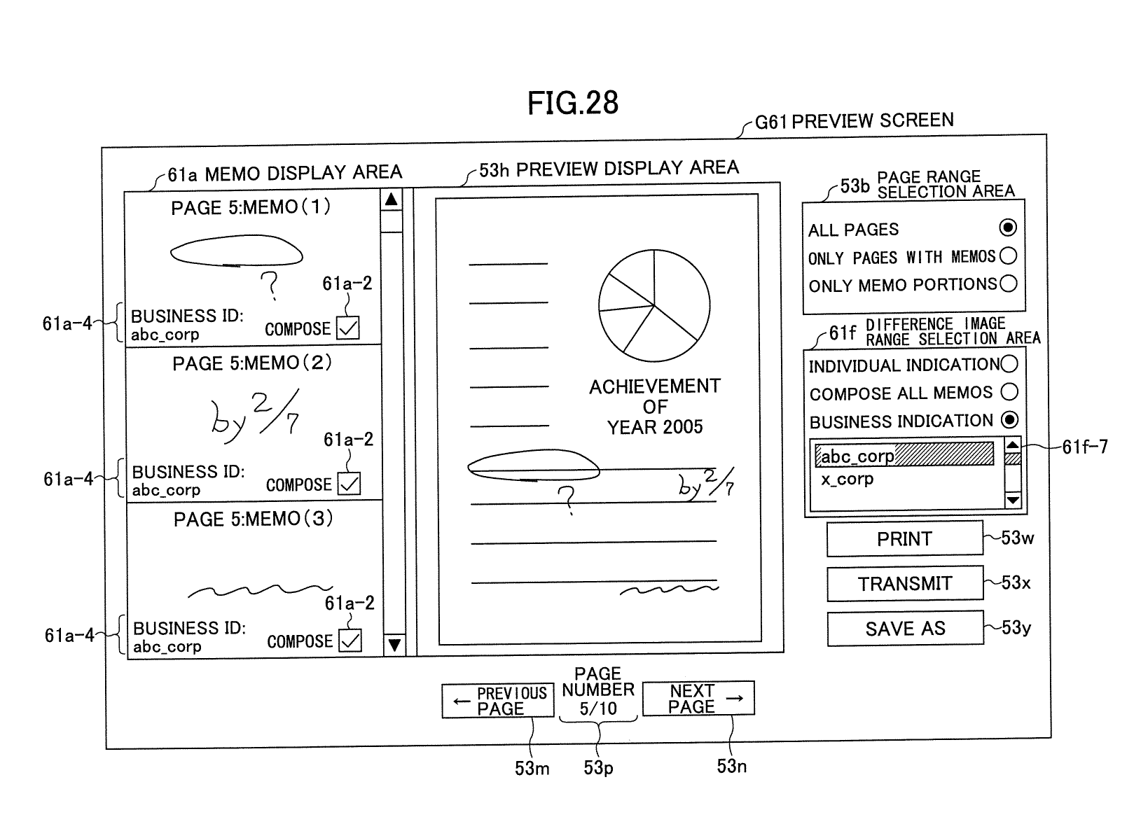

FIG. 28 is a diagram showing an example of the preview screen allowing indication of a range or the composition subject by the business. A configuration of the preview screen G61 shown in FIG. 28 is similar to that of the preview screen G53 in FIG. 25. In the preview screen G61 shown in FIG. 28, a memo display area 61a and a difference image range selection area 61f are configured, instead of the memo display area 53a and the difference image range selection area 53f, respectively. Accordingly, only the memo display area 61a and the difference image range selection area 61f will be described.

The memo display area 61a includes a check area 61a-2 for composing for each of the difference images 32, and a business ID display area 61a-4 that displays the business ID with which each of the difference images 32 is associated. The check area 61a-2 is similar to the check area 53a-2 of the preview screen G53 shown in FIG. 25. The business ID display area 61a-4 displays the difference image business ID as the property of the difference images 32 managed by the difference image management table 42b.

The difference image range selection area 61f includes selection items of “INDIVIDUAL INDICATION”, “COMPOSE ALL MEMOS”, “BUSINESS INDICATION”, and a like. The “INDIVIDUAL INDICATION” and the “COMPOSE ALL MEMOS” are the same as ones in the difference image range selection area 53f of the preview screen shown in FIG. 25. When the “BUSINESS INDICATION” is selected, a business selection area 61f-7 is enabled and the user selects the business from the business selection area 61f-7.

For example, when the user selects the “BUSINESS INDICATION” and selects “abc_corp” from the business selection area 61f-7, from the difference images 32 specified by “PAGE 5: MEMO (1)”, “PAGE 5: MEMO (2)”, and “PAGE 5: MEMO (3)” being displayed in the memo display area 61a, the difference images 32 of the “PAGE 5: MEMO (1)” and the “PAGE 5: MEMO (2)” are selected and composed with a page 5 of the original image 31 where the “abc_corp” is shown as the business ID at the business ID display area 61a-4. A composed image of page 5 is displayed in the preview display area 53h. Similarly, composed images of other pages are generated.

Since the user is allowed to select the business of the composition subject at the preview screen G61, it is possible to display the state in that the supplementary portions such as the handwritten memos are added regarding the business, at the preview display area 53h. For example, when the same document is used and modified individually for a plurality of business, it is possible to preview the handwritten memos as the composition subjects for each business, and it is possible to comprehend modification contents for each business.

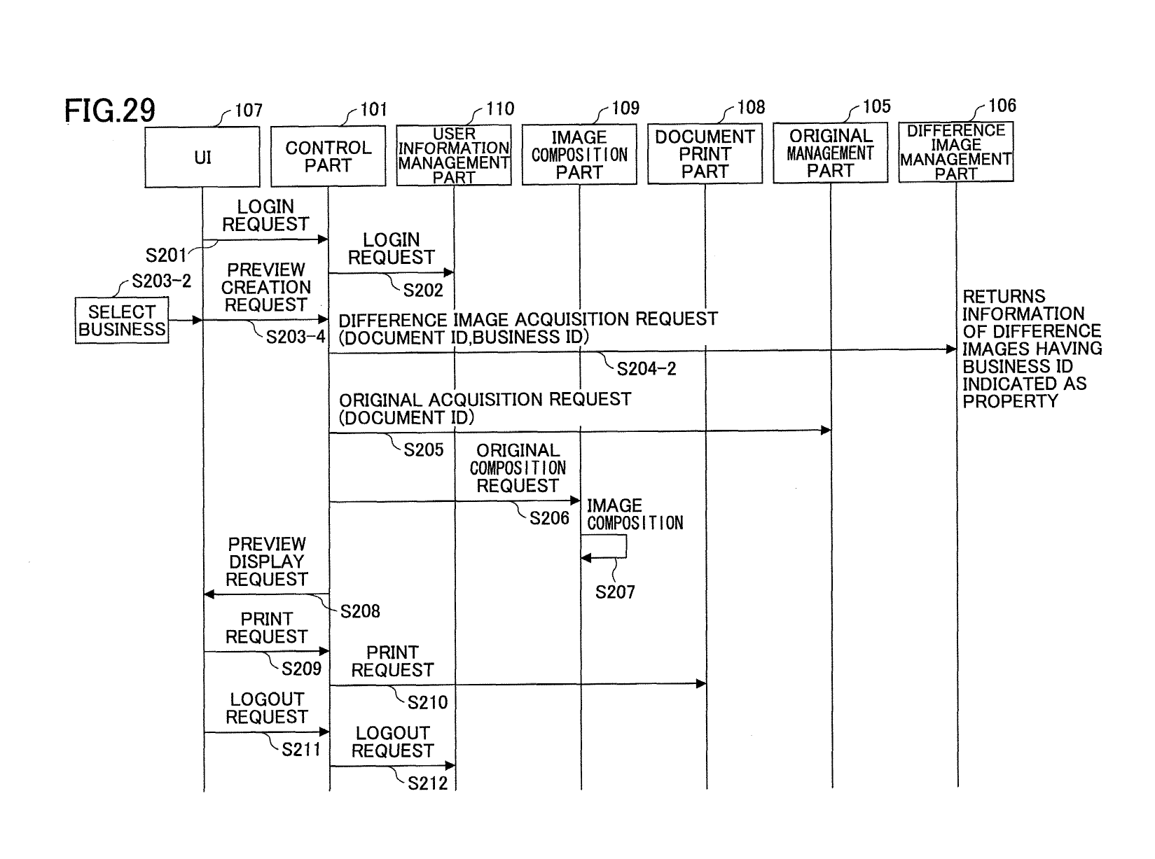

FIG. 29 is a diagram for explaining a sequence in a case of displaying and printing out pages at which the difference images 32 corresponding to the business are composed. In FIG. 29, steps that are the same as the ones in FIG. 15 are indicated by the same reference numerals and the explanation thereof will be omitted. It does not matter if the processing parts 103, 105, 106, and 110 are provided internally to or externally from the image processing apparatus 100a. Even in a case in that the processing parts 103, 105, 106, and 110 are accessed from the network 2, the sequence is the same, and a communication sequence through the network 2 is omitted in FIG. 29.

In FIG. 29, after login (steps S201 and S202), the user selects a desired document from a screen similar to the document list screen G50 shown in FIG. 13 displayed at the display part 107b and presses the preview button 50v, the preview screen G61 shown in FIG. 28 is displayed. The user selects the “BUSINESS INDICATION” from the preview screen G61, and further selects the business from the business selection area 61f-7 being enabled (step S203-2). In response to the selection of the business, the UI 107 sends a preview creation request to the control part 101 (step S203-4).

The control part 101 sends a difference image acquisition request indicating the document ID and the business ID to the difference image management part 106 (step S204-2). The difference image management part 106 reads out the difference images 32 by referring the difference image management table 42b stored in the storage area 2p by using the document ID and the business ID, and sends information concerning the difference images 32 to the control part 101. In this case, addresses where the difference images 32 are stored may be informed to the control part 101 by corresponding to the page number.

Next, the control part 101 instructs the original management part 105 to acquire the original image 31 corresponding to the document ID (step S205), and instructs the document print part 108 to compose the original image 31 and the difference images 32 based on the page number where the difference images 32 are composed (steps S206 and S207).

Subsequently, the control part 101 displays the image composition corresponding to the business selected by the user in the preview display area 53h of the preview screen G61 shown in FIG. 28 with respect to the UI 107 (step S208). When the user presses the print button 51w, the control part 101 instructs the document print part 108 to print out the composed image displayed in the preview display area 53h (steps S209 and S210).

After that, in response to a logout operation of the user, the control part 101 sends a logout request to the user information management part 110 (steps S211 and S212).

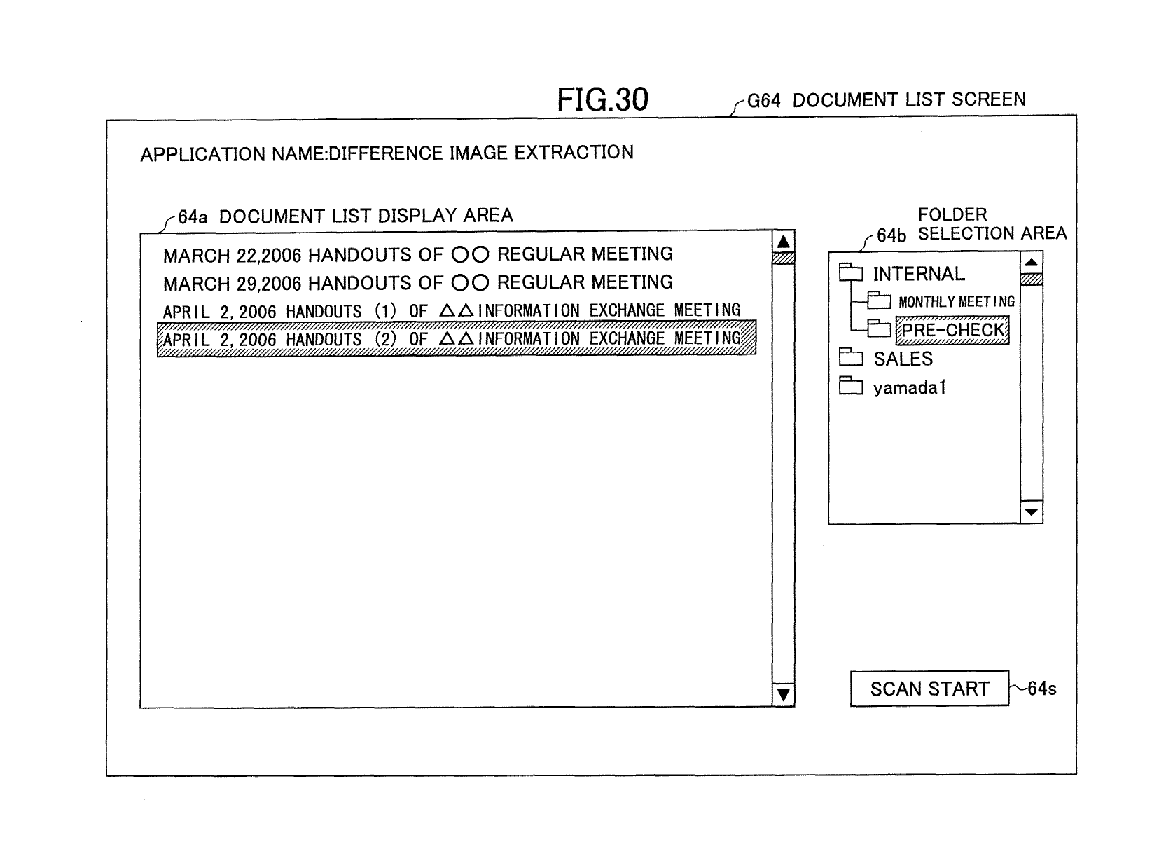

A case of using the difference image storage folder of the difference image management table 42b will be described. FIG. 30 is a diagram showing an example of the document list screen for extracting the difference images by indicating the business, according to the present invention. A document list screen G64 shown in FIG. 30 includes a document list display area 64a that displays a list of the documents which the original management part 105 maintains as the original image 31, a folder selection area 64b that displays a folder list allowing selecting a folder to store the difference images 32, and a scan start button 64s for extracting the difference images 32 by scanning the supplementary original 30a.

The user selects an original document name corresponding to the original 30 to which no supplementary portion such as a handwritten portion is added, from the document list display area 64a, selects a folder to which the supplementary portion is subject, from the folder selection area 64b, and presses the scan start button 64s. The supplementary original 30a in which the supplementary portions are added is scanned, and the extraction process of the difference images 32 is conducted by using the original image 31 of the original 30 selected by the user.

For example, in the folder selection area 64b, folders are shown in a hierarchical structure when the difference image management part 106 manages the difference images 32 in the hierarchical structure.

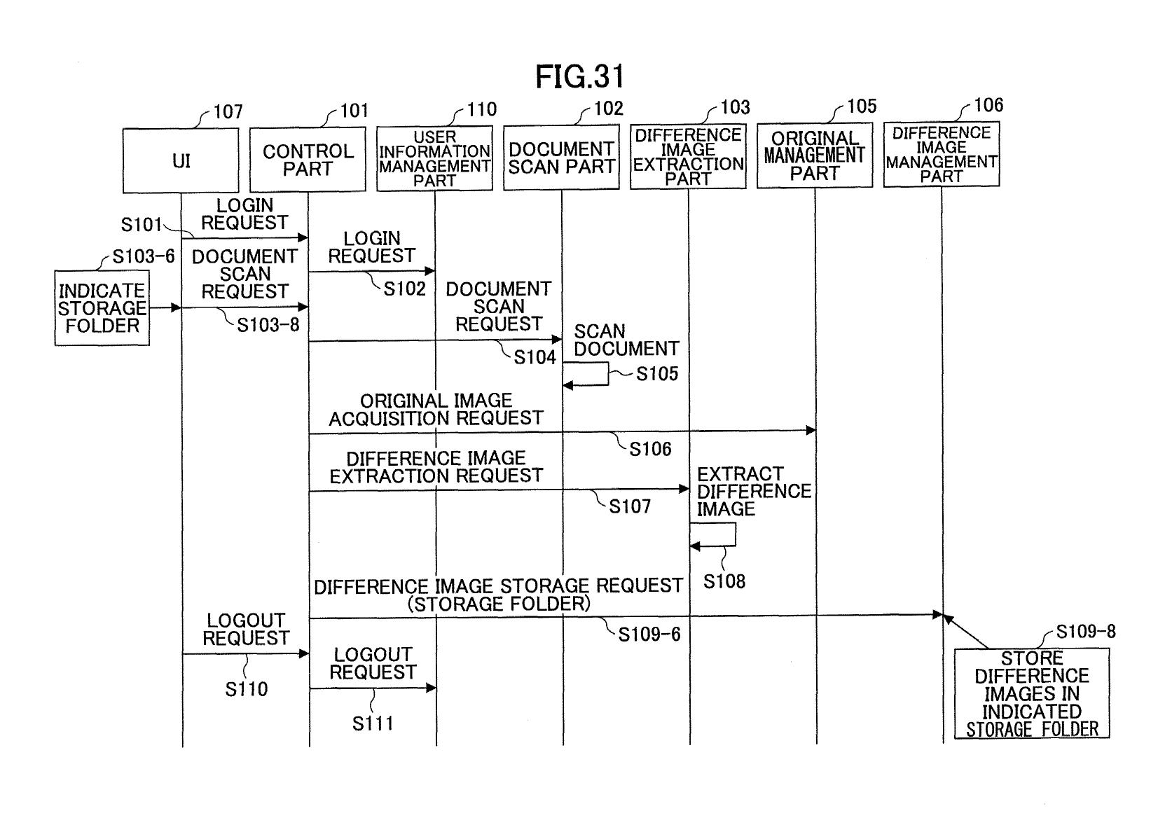

FIG. 31 is a diagram for explaining a sequence for storing the difference images 32 extracted by scanning the supplementary original 30a. In FIG. 31, steps that are the same as the ones in FIG. 27 are indicated by the same reference numerals and the explanation thereof will be omitted. It does not matter if the processing parts 103, 105, 106, and 110 are provided internally to or externally from the image processing apparatus 100a. Even in a case in that the processing parts 103, 105, 106, and 110 are accessed from the network 2, the sequence is the same, and a communication sequence through the network 2 is omitted in FIG. 30.

In FIG. 31, after login (steps S101 and S102), the control part 101 acquires information necessary to configure the document list screen G64 shown in FIG. 31 from the original management part 105, the difference image management part 106, and the like.

When the user indicates a storage folder at the folder selection area 64b and presses the scan start button 64s on the document list screen G64 (step S103-6), the UI 107 sends a document scan request to the control part 101 (step S103-8). The control part 101 instructs the document scan part 102 to read the supplementary original 30a (steps S104 and S105), acquires the original image 31 corresponding to a document name which the user selected from the document list screen G64 shown in FIG. 30, from the original management part 105 (step S106), and instructs the difference image extraction part 103 to extract the difference images 32 (steps S107 and S108).

The control part 101 sends the difference image store request to the difference image storage part 106 to store the difference images 32 extracted by the difference image extraction part 103 (step S109-6). The difference image store request includes at least a document ID, a page number, information indicating the storage folder, and the difference images 32 extracted by the difference image extraction part 103.

In response to the difference image store request, the difference image management part 106 additionally provides a difference image ID to each of the difference images 32 and stores the difference images 32 in the storage area 2p (step S109-8), so as to add records to the difference image management table 42b. In this case, the difference image business ID, the difference image creation date, and the difference image creation user ID may be omitted in the difference image store request.

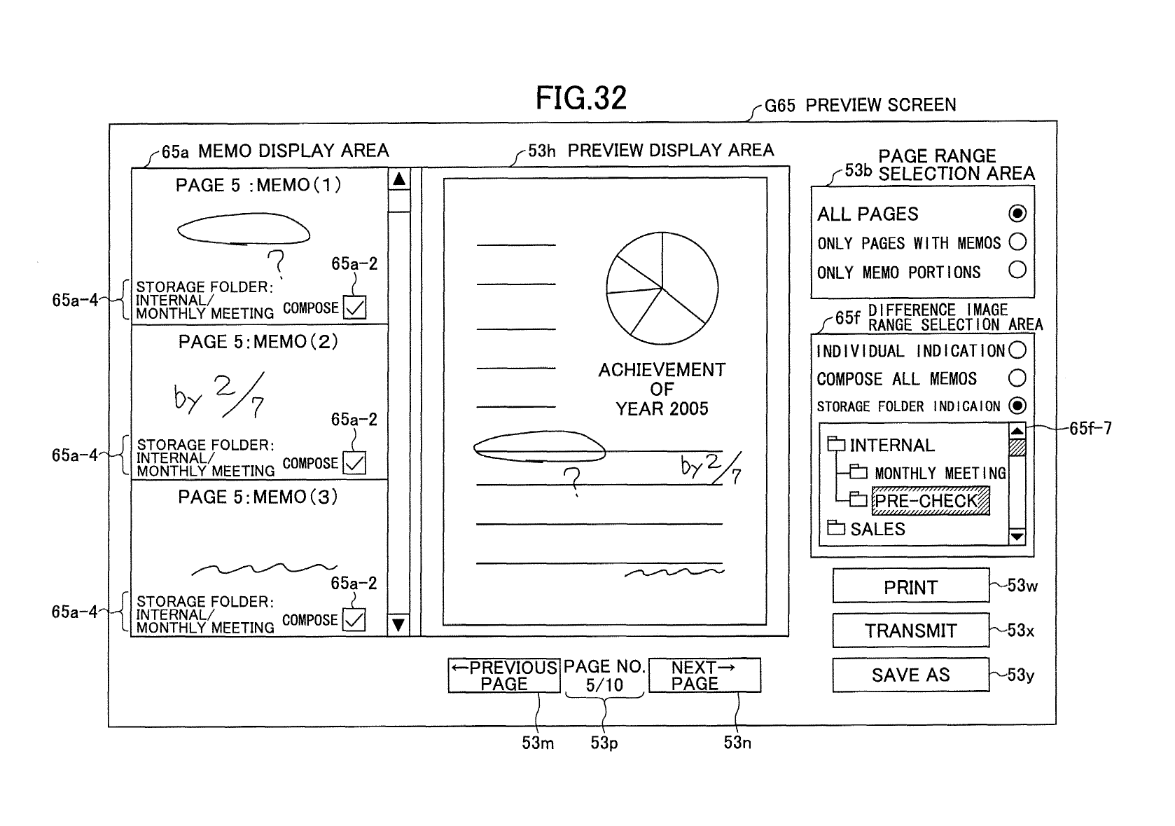

FIG. 32 is a diagram showing an example of the preview screen allowing indication of a range of the composition subject by the storage folder. A configuration of the preview screen G65 shown in FIG. 32 is similar to that of the preview screen G53 in FIG. 25. In the preview screen G65 shown in FIG. 32, a memo display area 65a and a difference image range selection area 65f are configured, instead of the memo display area 53a and the difference image range selection area 53f, respectively. Accordingly, only the memo display area 65a and the difference image range selection area 65f will be described.

The memo display area 65a includes a check area 65a-2 for checking whether or not to compose for each of the difference images 32, and a storage folder display area 65a-4 that displays a storage folder name concerning the difference images 32. The check area 65a-2 is the same as the check area 53a-2 of the preview screen G53 shown in FIG. 25. The storage folder display area 61a-4 displays values set to the difference image storage folder as the property of the difference images 32 managed by the difference image management table 42b.

The difference image range selection area 65f includes selection items of “INDIVIDUAL INDICATION”, “COMPOSE ALL MEMOS”, “STORAGE FOLDER INDICATION”, and a like. The “INDIVIDUAL INDICATION” and “COMPOSE ALL MEMOS” are the same as the ones in the difference image range selection area 53f of the preview screen G53 shown in FIG. 25. In a case of selecting the “STORAGE FOLDER INDICATION”, a storage folder selection area 65f-7 is enabled to select the storage folder, the user can select the storage folder from the storage folder selection area 65f-7.

For example, when the user selects the “STORAGE FOLDER INDICATION” and selects a folder “PRE-CHECK” under a folder “INTERNAL” from the storage folder selection area 65f-7, from the difference images 32 specified by “PAGE 5: MEMO (1)”, “PAGE 5: MEMO (2)”, and “PAGE 5: MEMO (3)” being displayed in the memo display area 65a, only the difference image 32 of the “PAGE 5: MEMO (3)” is selected and composed with a page 5 of the original image 31 where the “PRE-CHECK” is shown as the storage folder name at the storage folder display area 65a-4. A composed image of page 5 is displayed in a preview display area 53h. Similarly, composed images of other pages are generated.

Since the user can select the storage folder of the composition subject at the preview screen G65, it is possible to display the difference images 32 such as the handwritten memos stored in the storage folder selected by the user at the preview display area 53h.

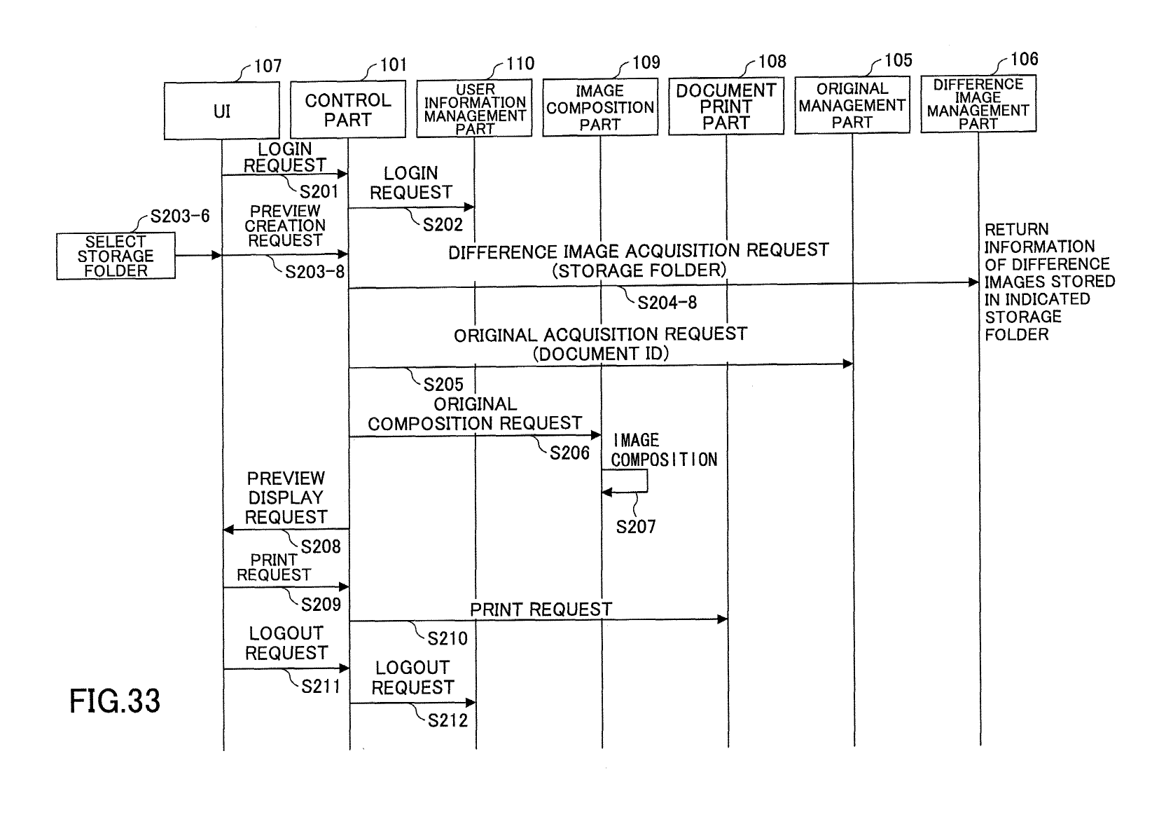

FIG. 33 is a diagram for explaining a sequence in a case of displaying and printing out pages at which the difference images 32 stored in the storage folder are composed. In FIG. 33, steps that are the same as the ones shown in FIG. 15 are indicated by the same reference numerals and the explanation thereof will be omitted. It does not matter if the processing parts 103, 105, 106, and 110 are provided internally to or externally from the image processing apparatus 100a. Even in a case in that the processing parts 103, 105, 106, and 110 are accessed from the network 2, the sequence is the same, and a communication sequence through the network 2 is omitted in FIG. 33.

In FIG. 33, after login (steps S201 and S202), when the user selects a desired document from a screen similar to the document list screen G50 shown in FIG. 13 displayed at the display part 107b and presses the preview button 50v, the preview screen G65 shown in FIG. 32 is displayed. When the user selects the “STORAGE FOLDER INDICATION” from the preview screen G65, and selects a desired storage folder from the storage folder selection area 65f-7 which is enabled (step S203-6). In response to the selection of the storage folder, the UI 107 sends a preview creation request to the control part 101 (step S203-8).

The control part 101 sends a difference image acquisition request including the document ID and information indicating the storage folder, to the difference image storage management part 106 (step S204-8). The difference image management part 106 refers to the difference image management table 42b stored in the storage area 2p, and reads out and informs the difference images 32 by using the document ID and information indicating the storage folder to the control part 101. In this case, addresses where the difference images 32 are stored may be informed to the control part 101 by corresponding to the page numbers.

Subsequently, the control part 101 acquires the original image 31 corresponding to the document ID to the original management part 105 (step S205), and composes the original image 31 and the difference images 32 based on the page numbers where the difference images 32 are composed (steps S206 and S207).

The control part 101 instructs the UI 107 to display the image composition corresponding to the storage folder selected by the user in the preview display area 53h of the preview screen G61 shown in FIG. 28 (step S208). When the user presses the print button 51w, the control part 101 instructs the document print part 108 to print out the composed image displayed at the preview display area 53h (steps S209 and S210).

After that, in response to a logout operation of the user, the control part 101 sends a logout request to the user information management part 110 (steps S211 and S212).

As described above, according to the present invention, a plurality of the difference images 32 corresponding to a plurality of portions of the original 30 are managed for each page where the difference images 32 are composed. The plurality of difference images 32 are extracted based on differences between the original 30 and the supplementary original 30a.

Although plurality of the difference images 32 are portion images extracted based on the differences between the original 30 and the supplementary original 30a, in a case of composing the original image 31 and the difference images 32, it is possible to select and compose the difference images 32 as composition subject associating with a indicated item.

The supplementary portions, which do not initially exist in the original 30, are managed by corresponding to subject items (for example, the user ID of a user who wrote a memo by hand, the creation date of the difference image 32, the business ID of the business related to a handwritten portion, the storage folder where the difference images 32 corresponding to the handwritten portion are stored, and the like). Accordingly, the difference images 32 of the supplementary portions corresponding to the subject item selected by the user are composed with the original image 31, and are displayed and printed out.

For example, in a case in that the user ID as the subject item is managed, copies of the original 30 are used by a plurality of users, and each of the users added memos by hand onto the copies of the original 30, since the difference image ID of each difference image corresponding to a handwritten memo is corresponded to the original 30 where the handwritten memo is added and the user of the handwritten memo, it is possible to browse and print out by composing handwritten memos of one or more users into one document.

Moreover, as only pages where the handwritten memos as the supplementary portions are determined as subject pages, it is possible to display and print out a composed image by composing the difference images 32 at the pages and the original image 31 at the pages. In addition, it is possible to display and print out a composed image by composing the difference images 32 and portion images of the original image 31 corresponding to rages of the difference images 32.

In a case in that the creation time of each of the difference images 32 are managed as the subject item, it is possible to compose the difference images 32 and the original image 31 for each page in a data range indicated by the user.

In a case in that the business ID is managed as the subject item, even if different supplementary portions are added with respect to the same original 30 at different businesses, it is possible to compose the difference images 32 associated with the business indicated by the user for each page.

In a case in that the storage folders of a hierarchical structure are managed as subject items, it is possible to maintain the difference images 32 in the hierarchical structure.

The present application is based on the Japanese Priority Patent Applications No. 2006-253508 filed Sep. 19, 2006 and No. 2007-233053 filed Sep. 7, 2007, the entire contents of which are hereby incorporated by reference.

What is claimed is:

1. An image management method for managing images, wherein:
a scan part generates a supplementary original image by scanning a supplementary original; and
a portion image management part manages a plurality of portion images corresponding to a plurality of supplementary portions extracted by using the supplementary original image.

2. The image management method as claimed in claim 1, wherein:
the portion image management part manages subject items indicating subjects to which the plurality of portion images are related by corresponding to the plurality of portion images; and
an image composition part selectively composes the plurality of portion images and an original image based on the subject items.

3. The image management method as claimed in claim 2, wherein:
a portion image extraction part extracts the plurality of portion images based on differences between the supplementary original image and the original image; and
the portion image management part manages the plurality of portion images extracted by the portion image extraction part.

4. The image management method as claimed in claim 3, wherein the portion image management part manages values of the subject items indicated by a user by corresponding to the plurality of portion images.

5. The image management method as claimed in claim 2, wherein:
the portion image management part manages the plurality of portion images so that one or more portion images are corresponded to one page of an original; and
the image composition part composes the plurality of portion images with an original image at pages where the portion images are composed.

6. The image management method as claimed in claim 2, wherein the image composition part composes the plurality of portion images with original portion images of an original image including areas of the portion images at pages where the portion images are composed, and generates portion composed images.

7. The image management method as claimed in claim 6, wherein an image layout part arranges the portion composed images generated by the portion composition part so as to meet a size of a predetermined sheet.

8. The image management method as claimed in claim 7, wherein the portion composed images being laid out are displayed at a display part and are changeable by an operation of a user.

9. The image management method as claimed in claim 8, wherein:
the display part previews the portion composed images composed by the image composition part or laid out by the image layout part; and
a print part prints out the portion composed images composed by the image composition part or laid out by the image layout part on a predetermined sheet.

10. The image management method as claimed in claim 1, wherein the portion image management part manages at least one of a user ID of a user related to the supplementary portion, a creation date of the portion image, a business ID of a business related to the portion image, and information indicating a storage folder where the portion image is stored, as subject items by corresponding to the portion image.

11. An image processing apparatus, comprising:
a supplementary original scan part configured to generate a supplementary original image by scanning a supplementary original; and
a portion image management part configured to manage a plurality of portion images corresponding to a plurality of supplementary portions extracted by using the supplementary original image.

12. The image management apparatus as claimed in claim 11, wherein:
the portion image management part manages subject items indicating subjects to which the plurality of portion images are related by corresponding to the plurality of portion images
the image management apparatus further comprises an image composition part configured to selectively compose the plurality of portion images and an original image based on the subject items.

13. The image processing apparatus as claimed in claim 11, wherein at least one of the original image and the plurality of portion images is stored in an external server.
